(19) United States
(12) Patent Application Publication
(10) Pub. No.: US 2005/0193257 A1
(43) Pub. Date: Sep. 1, 2005

(54) System and method for improving network reliability

(75) Inventor: Assaf Stoler, Garden Grove, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: Matsushita Avionics Systems Corporation

(21) Appl. No.: 11/086,510

(22) Filed: Mar. 21, 2005

Related U.S. Application Data
(63) Continuation-in-part of application No. 10/773,523, filed on Feb. 6, 2004.

(51) Int. Cl. G06F 11/00

(52) U.S. Cl. 714/31

(57) ABSTRACT

A network management system for detecting and remedying malfunctions in network devices and methods for manufacturing and using same. An information system includes a plurality of network devices for performing selected functions and a network management system for detecting malfunctions in the network devices. Preferably comprising a plurality of network management system and being distributed among the network devices, the network management system receives status signals from each of the network devices. Upon evaluating the status signals, the network management system determines whether any of the network devices have malfunctioned and, if so, provides a suitable response to the malfunction. The network management system likewise can identify appropriate corrective action for remedying the malfunction and can temporarily redirect functions originally performed by the malfunctioning network device to other network devices while the malfunction is being remedied. Thereby, malfunctions can be remedied in a manner that is transparent to system users.

### CROSS-REFERENCE TO RELATED APPLICATIONS

This application is a continuation-in-part of co-pending U.S. patent application Ser. No. 10/773,523, filed on Feb. 6, 2004. Priority to the prior application is expressly claimed, and the disclosure of the application is hereby incorporated by reference in its entirety.

### FIELD OF THE INVENTION

The present invention relates generally to network management systems and more particularly, but not exclusively, to network management systems for detecting and remedying malfunctions in network devices.

### BACKGROUND OF THE INVENTION

As computer systems and networks continue to become more integral in the manner by which business and personal matters are conducted, system users have grown more dependent upon the reliability of these systems. Theses computer systems and networks likewise have grown to rely upon central server systems, which are essential to the operation of the computer systems and networks and which must remain operational at all times. Therefore, system manufacturers and users have grown increasingly concerned with system malfunctions.

Detecting and responding to system malfunctions can prove difficult due to the complexity of current network systems as well as the large number of local and remote computer systems that can be coupled therewith. Further, computer systems and networks can malfunction as a result of any of a variety of causes and can become manifest in an assortment of different ways. If the computer system or network experiences a malfunction, therefore, a user typically will be become aware of the malfunction but will only be able to speculate as to the precise nature and cause of the malfunction.

Network management systems have been developed to assist with the management of computer systems and networks. Since network systems can support a significant volume of information and a large number of network devices, contemporary network management systems must be able to support large network systems and be scalable to manage any number of network devices. In addition to being cost-effective, the network management systems also must maintain consistent performance and reliability. It is necessary, therefore, to test the network management systems for scalability, performance, and reliability prior to deployment as well as afterward to ensure that consistent performance and reliability can be maintained.

In view of the foregoing, a need exists for an improved network management system that overcomes the aforementioned obstacles and deficiencies of currently-available network management systems.

### SUMMARY OF THE PREFERRED EMBODIMENTS

The present invention is directed toward a network management system for detecting malfunctions in network devices and for providing suitable responses to the malfunctions.

An information system can comprise at least one network device for communicating with other network devices and a network management system. Preferably disposed within one or more of the network devices, the network management system is configured to receive status signals from the network devices. The status signals provide information, such as an operational status and/or current performance data, pertaining to the selected network devices. Upon evaluating the status signals, the network management system can determine whether any of the network devices have malfunctioned and, if so, can provide suitable responses to the malfunction.

Preferably, the network management system likewise is configured to identify appropriate corrective action for remedying the malfunction. The network management system can provide a control signal, which includes information related to the appropriate corrective action, and can provide the control signal to one or more relevant network devices. The relevant network devices, upon receiving the control signal, are configured to implement the corrective action identified in the control signal in accordance with any implementation instructions included therewith. The network management system thereby can detect and remedy any malfunctions occurring in the network devices.

Other aspects and features of the present invention will become apparent from consideration of the following description taken in conjunction with the accompanying drawings.

### BRIEF DESCRIPTION OF THE DRAWINGS

FIG. 1 is an exemplary top-level block diagram of an embodiment of an information system that includes a network device and a network management system for detecting and remedying malfunctions in the network device.

FIG. 2 is an exemplary top-level block diagram illustrating an alternative embodiment of the information system of FIG. 1 in which the information system includes a plurality of network devices and the network management system detects and remedies malfunctions in at least one of the network devices.

FIG. 3A is an exemplary top-level block diagram illustrating one embodiment of the information system of FIG. 2 in which the network management system is configured to communicate with the network devices substantially via the communication network.

FIG. 3B is an exemplary top-level block diagram illustrating an alternative embodiment of the information system of FIG. 3A in which the network management system is configured to communicate with the network devices substantially independently of the communication network.

FIG. 4 is an exemplary block diagram illustrating one embodiment of a network system and a network management system for the information system of FIG. 2.

FIG. 5A illustrates an exemplary timing diagram of the status signal provided by a selected network device of FIG. 4 in which the status signal comprises a series of pulse signals.

FIG. 5B illustrates an exemplary timing diagram of the status signal of FIG. 5A in which the pulse signals are substantially uniform in amplitude, duration, and period.

FIG. 6 illustrates an exemplary timing diagram of the status signals provided by the network devices of the information system of FIG. 4.

FIG. 7A is a detail drawing illustrating one embodiment of a selected network device for the information system of FIG. 4 in which the network device includes a timing system for providing the status signals.

FIG. 7B is a detail drawing illustrating an alternative embodiment of the network device of FIG. 7A in which the timing system is substantially embedded in a processing system.

FIG. 7C is a detail drawing illustrating another alternative embodiment of the network device of FIG. 7B in which a memory system is substantially embedded in the processing system.

FIG. 8A is a detail drawing illustrating one embodiment of a signal processing system for the network management system of FIG. 4 in which the signal processing system is provided as an active signal processing system.

FIG. 8B illustrates an exemplary timing diagram of an enable signal provided by the signal processing system of FIG. 8A in response to the status signal of FIG. 5A.

FIG. 9A is a detail drawing illustrating an alternative embodiment of the signal processing system of FIG. 8A in which the signal processing system is provided as a passive signal processing system.

FIG. 9B illustrates an exemplary timing diagram of the enable signal provided by the signal processing system of FIG. 9A in response to the status signal of FIG. 5B.

FIG. 10A is a detail drawing illustrating one embodiment of the network management system of FIG. 4 in which the network management system includes a processing system for providing communication signals to a signal processing system.

FIG. 10B is a detail drawing illustrating an alternative embodiment of the network management system of FIG. 10A in which the signal processing system can receive at least a portion of the communication signals substantially independently of the processing system.

FIG. 10C is a detail drawing illustrating another alternative embodiment of the network management system of FIG. 10A in which the signal processing system can receive at least a portion of the communication signals as substantially serial communication signals.

FIG. 10D is a detail drawing illustrating another alternative embodiment of the network management system of FIG. 10A in which the signal processing system can receive at least a portion of the communication signals as substantially parallel communication signals.

FIG. 11A is an exemplary block diagram illustrating one embodiment of a signal processing system for the network management system of FIG. 4 in which the signal processing system is configured to receive status signals from, and provide a plurality of enable signals associated with, a plurality of network devices.

FIG. 11B is a detail drawing illustrating one embodiment of the signal processing system of FIG. 11A in which the network devices is associated with a substantially independent signal processing subsystems.

FIG. 11C is a detail drawing illustrating one embodiment of the signal processing system of FIG. 11A in which two or more network devices can be associated with a selected signal processing subsystem.

FIG. 11D is a detail drawing illustrating an alternative embodiment of the signal processing system of FIG. 11C in which the selected signal processing subsystem is configured to receive substantially separate status signals from two or more predetermined network devices and to provide a composite enable signal that is associated with at least one of the predetermined network devices.

FIG. 11E is a detail drawing illustrating an alternative embodiment of the signal processing system of FIG. 11C in which the selected signal processing subsystem is configured to receive a composite status signal from two or more predetermined network devices and to provide substantially separate enable signals that are associated with at least one of the predetermined network devices.

FIG. 11F is a detail drawing illustrating an alternative embodiment of the signal processing system of FIG. 11C in which the selected signal processing subsystem is configured to receive a composite status signal from two or more predetermined network devices and to provide a composite enable signal that is associated with at least one of the predetermined network devices.

FIG. 12A is an exemplary block diagram illustrating another alternative embodiment of the information system of FIG. 2 in which two or more of the network devices are configured to perform at least one common function.

FIG. 12B is an exemplary block diagram illustrating an alternative embodiment of the information system of FIG. 12A in which the network system provides at least one virtual network device that is associated with the common function and that is configured to redirect the common function if one of the associated network devices malfunctions.

FIG. 12C is an exemplary block diagram illustrating an alternative embodiment of the information system of FIG. 12B in which the virtual network device is further configured to detect malfunctions in the associated network devices.

FIG. 13A is an exemplary top-level block diagram illustrating an alternative embodiment of the information system of FIG. 1 in which the network management system is at least partially disposed within the network device.

FIG. 13B is an exemplary top-level block diagram illustrating an alternative embodiment of the information system of FIG. 13A in which the information system comprises a plurality of network devices and the network management system is disposed within, and distributed among, the network devices.

FIG. 14A is an exemplary block diagram illustrating another alternative embodiment of the information system of FIG. 1 in which two or more network devices are configured to perform at least one common function.

FIG. 14B is an exemplary block diagram illustrating an alternative embodiment of the information system of FIG. 14A in which the network system provides at least one virtual network device that is associated with the common function and that is configured to redirect the common function if one of the associated network devices malfunctions.

FIG. 14C is an exemplary block diagram illustrating an alternative embodiment of the information system of FIG. 14B in which the virtual network device includes a virtual network management system for detecting and remedying malfunctions in the associated network devices.

FIG. 15 is a detail drawing illustrating another alternative embodiment of the information system of FIG. 1 in which the information system is configured as a passenger entertainment system installed in a vehicle, such as an aircraft.

It should be noted that the figures are not drawn to scale and that elements of similar structures or functions are generally represented by like reference numerals for illustrative purposes throughout the figures. It also should be noted that the figures are only intended to facilitate the description of the preferred embodiments of the present invention. The figures do not describe every aspect of the present invention and do not limit the scope of the invention.

### DETAILED DESCRIPTION OF THE PREFERRED EMBODIMENTS

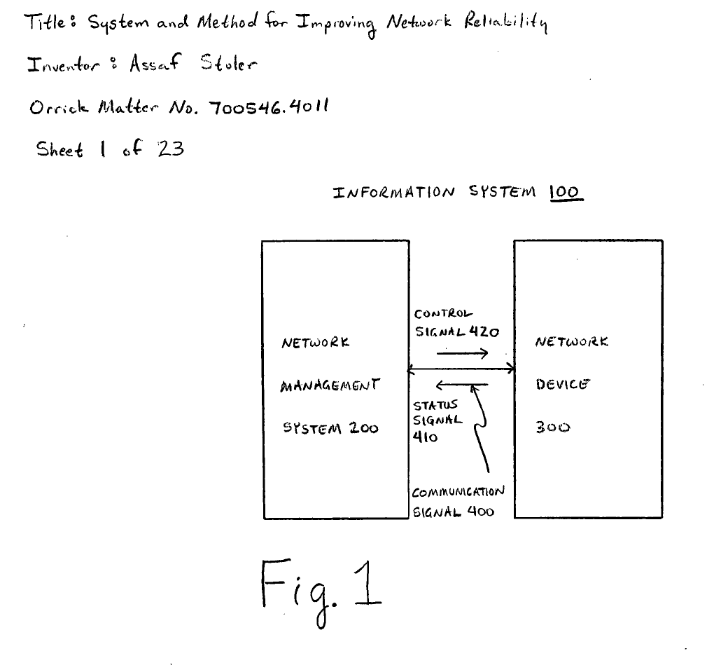

Since currently-available network management systems provide limited scalability, performance, and reliability, a network management system that can support large network systems with any number of network devices can prove much more desirable and provide a basis for a wide range of information system applications, such as passenger entertainment systems for use on aircraft and other types of vehicles. This result can be achieved, according to one embodiment of the present invention, by employing an information system 100 as illustrated in FIG. 1.

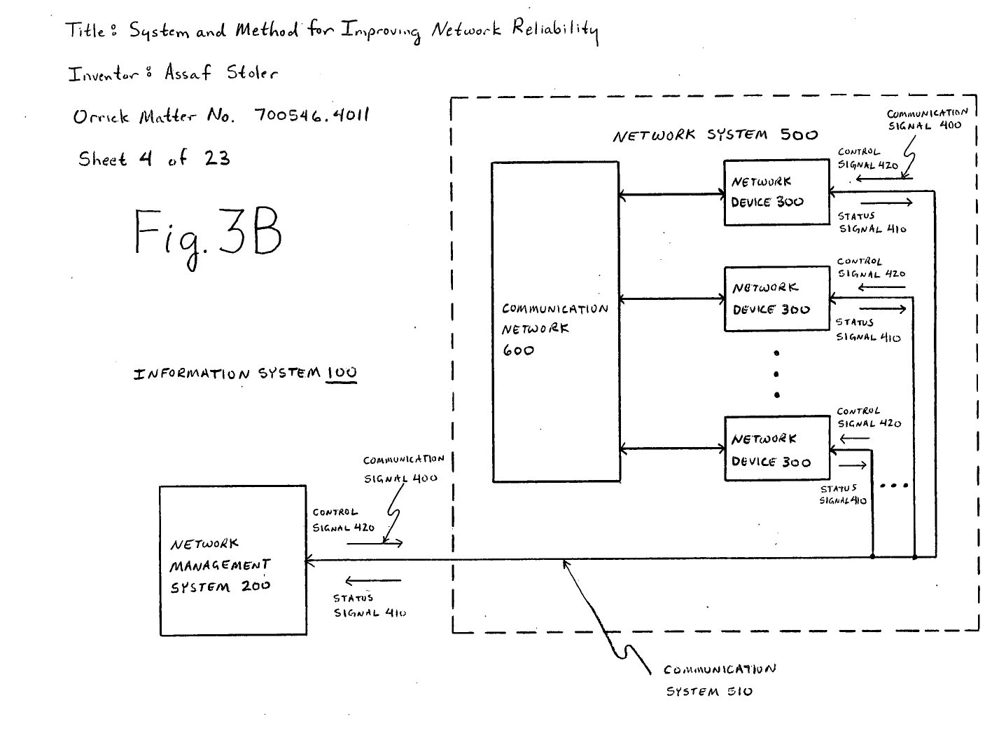

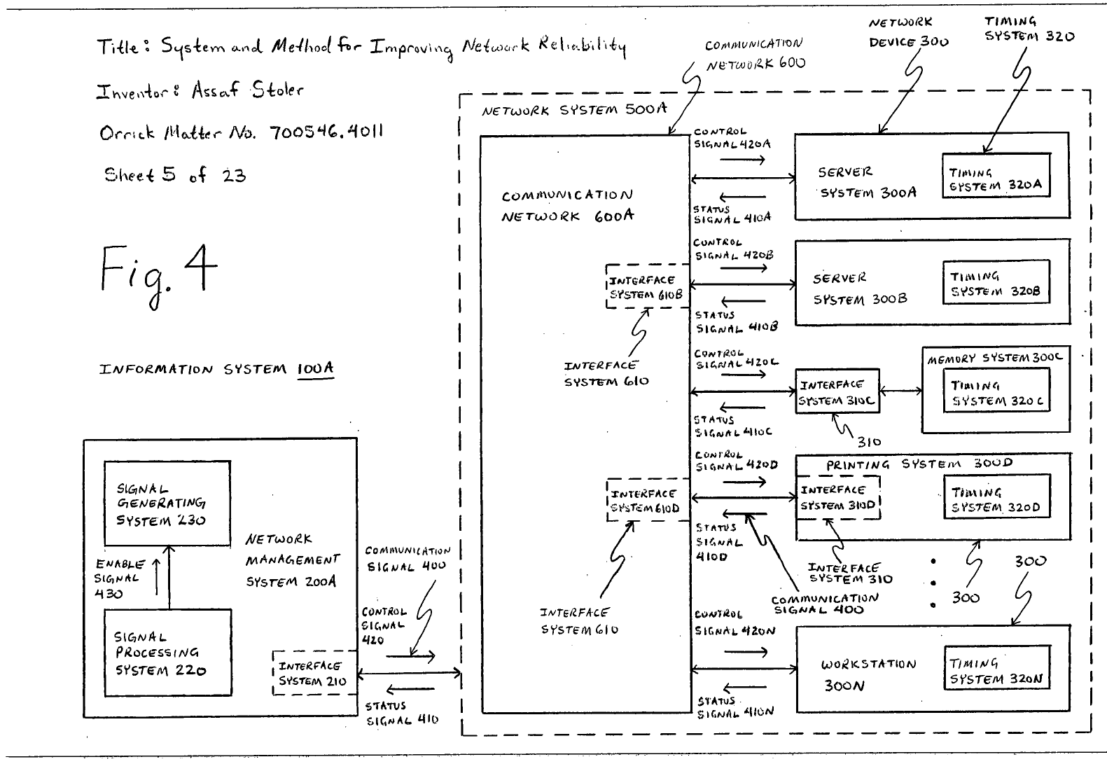

The information system 100 shown in FIG. 1 includes at least one network device 300 that is configured to communicate with a network management system 200. The network device 300 can comprise any suitable type of network device, such as a server system 300A, 300B (shown in FIG. 4), a memory system 300C (shown in FIG. 4), a printing system 300D (shown in FIG. 4), and/or a workstation 300N (shown in FIG. 4), and is configured to exchange communication signals 400 with the network management system 200. For example, the communication signals 400 can include a status signal 410 provided by the network device 300. The status signal 410 preferably includes information, such as an operational status and/or performance data, pertaining to the network device 300.

Being configured to receive the status signals 410 from the network device 300, the network management system 200 is configured to detect malfunctions in the network device 300. The network management system 200 can be provided in any suitable manner, such as via one or more hardware components and/or software components, and, upon receiving the status signal 410, can evaluate the information provided by the status signal 410 to determine whether a malfunction has occurred with regard to the network device 300. If the network device 300 has malfunctioned, the network management system 200 likewise can be configured to suitably respond to the malfunction. The network management system 200 can respond to the malfunction by attempting to remedy the malfunction, for example, by identifying one or more appropriate corrective actions for remedying the malfunction.

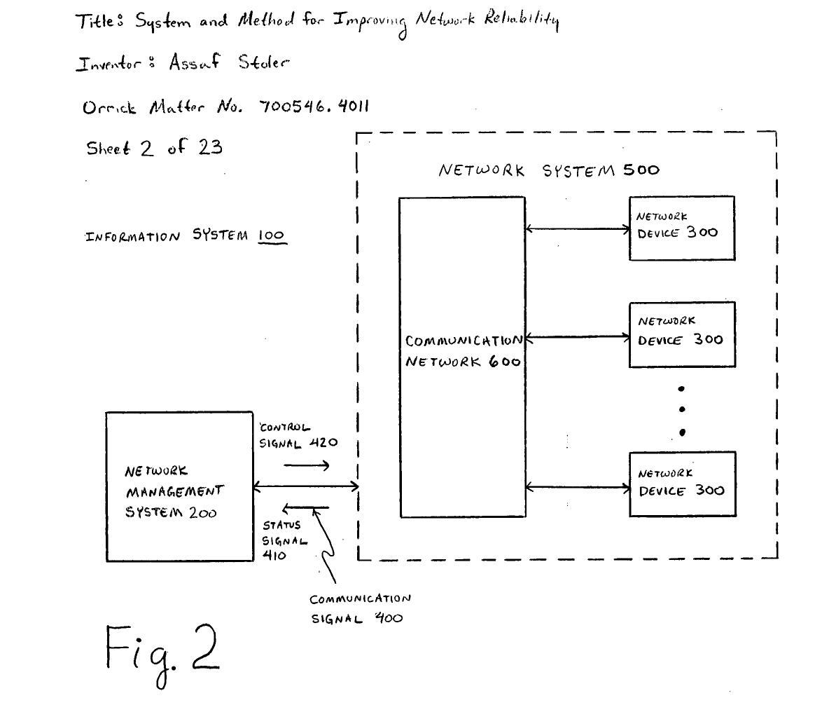

Exemplary corrective actions can include restarting at least one hardware and/or software component of the malfunctioning network device 300, restarting at least one hardware and/or software component of the network system 500 (shown in FIG. 2) to which the malfunctioning network device 300 is coupled, and/or at least temporarily redirecting one or more functions performed by the malfunctioning network device 300 to one or more other selected network devices 300. The network management system 200 likewise can elect to reload one or more software components, such as a network device driver and/or application software, associated with the malfunctioning network device 300 and/or to ignore the malfunction such that no corrective action is taken to remedy the malfunction. It will be appreciated that the corrective actions enumerated above are merely exemplary and not exhaustive.

The network management system 200 likewise can provide a control signal 420 to the malfunctioning network device 300. If the network device 300 has malfunctioned, the control signal 420 can include information related to the appropriate corrective action for remedying the malfunction. The network management system 200 may provide no control signal 420, for example, in the absence of a malfunction or upon electing to ignore the malfunction. As desired, instruction for implementing the corrective action can be included in the information provided by the control signal 420. For instance, the network management system 200 may determine that the malfunction in the network device 300 can be remedied by more than one corrective action, such as two or more corrective actions in the alternative and/or in combination. Exemplary instructions can include a sequence by which the corrective actions can be implemented and/or a predetermined number of times by which a selected corrective action can be attempted.

Upon receiving the control signal 420, the network device 300 is configured to implement the corrective action identified in the control signal 420 in accordance with any implementation instructions included therewith. The network device 300 can provide the result of implementing the corrective action to the network management system 200 via a subsequent status signal 410 such that the network management system 200 can determine whether any further corrective action is warranted and/or desirable in the manner discussed above. Thereby, the network management system 200 is configured to detect and remedy malfunctions, if any, in the network device 300, preferably in a manner that is substantially transparent to a system user. Although shown and described with reference to FIG. 1 as comprising one network management system 200 and one network device 300 for purposes of illustration, the information system 100 can include any suitable number of network management systems 200 and network devices 300 in which each network management system 200 can be configured to communicate with one or more network devices 300.

Turning to FIG. 2, for example, the illustrated information system 100 comprises a network management system 200 that is configured to communicate with a network system 500 having a plurality of network devices 300. Typically being provided as a conventional computer network system, the network system 500 can comprise a network system of any suitable type such that the network devices 300 are configured to communicate. The network system 500, for example, can be provided as a wired and/or wireless communication network, including a local area network (LAN), a wide area network (WAN), a campus-area network (CAN), and/or a wireless local area network (WLAN), of any kind. Exemplary wireless local area networks include wireless fidelity (Wi-Fi) networks in accordance with Institute of Electrical and Electronics Engineers (IEEE) Standard 802.11 and/or wireless metropolitan-area networks (MANs), which also are known as WiMax Wireless Broadband, in accordance with IEEE Standard 802.16.

The network system 500 likewise can be provided with any appropriate network topology, protocol, and/or architecture. Comprising a geometric arrangement of the network devices 300, conventional network topologies include mesh, star, bus, and ring network topologies. The topology of the network system 500 likewise can comprise a hybrid of the conventional network topologies such as a network tree topology. Network protocols define a common set of rules and signals by which the network devices 300 can communicate via the network system 500. Illustrative types of conventional network protocols include Ethernet and Token-Ring network protocols; whereas, peer-to-peer and client/server network architectures are examples of conventional network architectures. It will be appreciated that the network system types, topologies, protocols, and architectures identified above are merely exemplary and not exhaustive.

In the manner described in more detail above with reference to FIG. 1, the network devices 300 each are configured to provide at least one status signal 410 that includes information, such information with regard to any malfunctions, concerning the respective network devices 300. The network devices 300 can provide the status signals 410 to the network system 500, which, in turn, provides the status signals 410 to the network management system 200. Upon receiving the status signals 410, the network management system 200 is configured to provide control signals 420 in the manner described in more detail above with reference to FIG. 1. The control signals 420 preferably include information related to appropriate corrective action for remedying any malfunction of the respective network devices 300.

The network management system 200 can provide the control signals 420 to preselected network devices 300 via the network system 500. For example, the preselected network devices 300 can include any network devices 300 in which a malfunction has occurred. In the manner set forth above, the preselected network devices 300, upon receiving the control signals 420, are configured to implement the associated corrective action and, as desired, can provide the result to the network management system 200 via the network system 500 such that the network management system 200 can determine whether any further corrective action is warranted and/or desirable. Thereby, the network management system 200 is configured to detect and remedy malfunctions, if any, in the plurality of network devices 300.

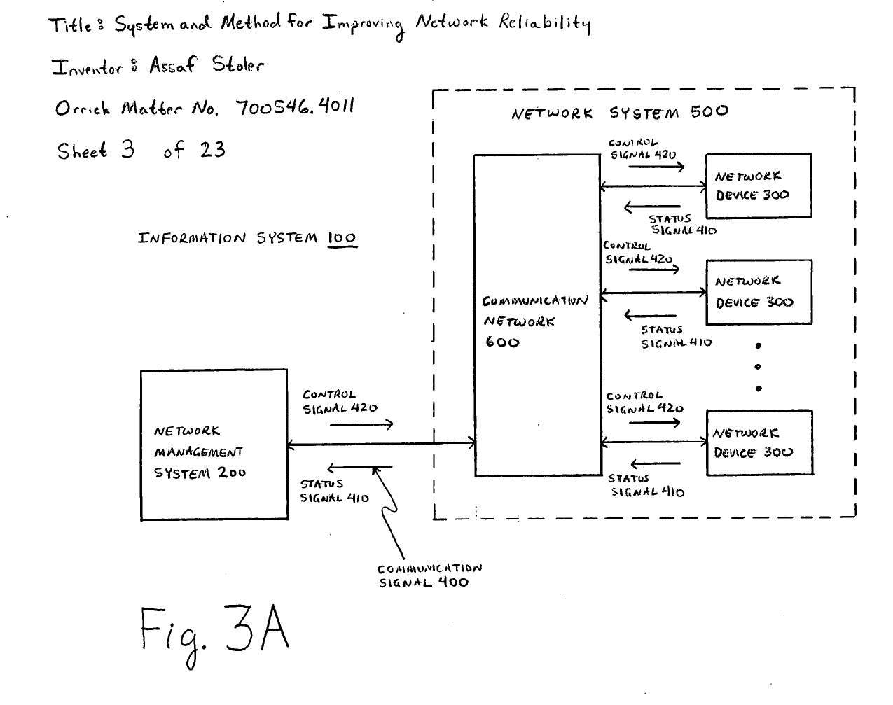

The network system 500 can be configured to facilitate the exchange communication signals 400 between the network devices 300 and the network management system 200 in any appropriate manner. For example, the network devices 300 can be directly and/or indirectly coupled and configured to communicate and are shown in FIG. 2 as being coupled, and configured to communicate, via a communication network 600. In the manner described above with reference to the network system 500, the communication network 600 can be provided as any suitable type of conventional communication network such that the network devices 300 can communicate. The communication network 600 likewise can be coupled with, and configured to communication with, the network management system 200 as illustrated in FIG. 3A. Thereby, the network management system 200 and the respective network devices 300 can exchange the status signals 410 and the control signals 420 via the communication network 600 such that the network management system 200 can detect and remedy malfunctions in the respective network devices 300 in the manner set forth above with reference to FIG. 2.

Alternatively, or in addition, the network management system 200 can be coupled with, and configured to communicate with, one or more of the respective network devices 300 independently of the communication network 600. For example, the network system 500 can include a communication system 510 as shown in FIG. 3B. Being substantially independent of the communication network 600, the communication system 510 can comprise a substantially dedicated communication connection that couples the network management system 200 and one or more preselected network devices 300 such that communication signals 400 can be exchanged between the network management system 200 and the preselected network devices 300. The network management system 200 thereby can detect and remedy malfunctions in the preselected network devices 300 even if the communication network 600 likewise is malfunctioning in the manner set forth above with reference to FIG. 2.

FIG. 4 illustrates an information system 100A that comprises a network management system 200A and one or more network devices 300. Exemplary network devices 300 can include one or more server systems 300A, 300B, memory systems 300C, printing systems 300D, and/or workstations 300N as shown in FIG. 4. In the manner discussed in more detail above with reference to FIGS. 2 and 3A-B, the network devices 300 can be configured to communicate via a communication network 600A such that the network devices 300 and the communication network 600A form a network system 500A as shown in FIG. 4. Likewise being configured to communicate with the network system 500A, the network management system 200A can exchange communication signals 400 with the network devices 300 in the manner set forth above. The network devices 300 can be coupled with, and configured to communicate with, the network system 500A and/or the communication network 600A in any appropriate quantity and/or arrangement. The network management system 200 thereby can detect and remedy malfunctions in the network devices 300 as discussed above regarding FIG. 2.

Being configured to communicate via the communication network 600A, the network devices 300 can be coupled with the communication network 600A directly or indirectly, for example, via one or more interface systems 310. The interface systems 310 preferably comprise conventional communication interface systems and can include one or more hardware components, such as a network interface card, and/or one or more software components, such as a device driver. As illustrated in FIG. 4, the printing system 300D is coupled with, and configured to communicate with, the communication network 600A via an interface system 310D. The interface system 310D is disposed substantially between the printing system 300D and the communication network 600A and is configured to facilitate the exchange of the communications signals 400 between the printing system 300D and the communication network 600A, and, therefore, other network devices 300 and/or the network management system 200A. If the communication network 600A comprises a telephone network (not shown), for example, the interface system 310A can comprise a modem for coupling the server system 300A with the telephone network.

Although shown and described as being disposed substantially within the printing system 300D, the interface system 310D can be disposed substantially within, or separate from, the printing system 300D. For example, FIG. 4 shows the memory system 300C as being coupled with the communication network 600A via an interface system 310C. Being provided in the manner described above with reference to the interface system 310D, the interface system 310C as illustrated in FIG. 4 is substantially separate from the memory system 300C. The interface system 310C is disposed substantially between the memory system 300C and the communication network 600A and is configured to facilitate the exchange of the communications signals 400 between the memory system 300C and the communication network 600A, and, therefore, other network devices 300 and/or the network management system 200A in the manner discussed above. The server system 300A and the workstation 300N are substantially directly coupled with the communication network 600A as shown in FIG. 4.

The communication network 600A likewise can include interface systems 610 for indirectly coupling the communication network 600A with one or more network devices 300. Preferably comprising conventional communication interface systems, the interface systems 610 can include one or more hardware components, such as a network hub with a predetermined number of communication ports, and/or one or more software components, such as a device driver. In the manner set forth above with reference to the interface systems 310, the interface systems 610 are configured to facilitate the exchange of the communications signals 400 among the network devices 300 and/or the network management system 200A and can be disposed substantially within, or separate from, the communication network 600A.

As illustrated by the server system 300A and the workstation 300N in FIG. 4, the communication network 600A can be substantially directly coupled with one or more network devices 300. One interface system 610 can be disposed between the communication network 600A and the relevant network device 300 in the manner discussed above with reference to the interface system 310. The server system 300B, for example, is shown in FIG. 4 as being coupled with the communication network 600A via an interface system 610B. As desired, the communication network 600A and the relevant network device 300 can be coupled via two interface systems 310, 610 as illustrated by the coupling between the communication network 600A and the printing system 300D. FIG. 4 illustrates the communication network 600A having an interface system 610D for coupling the communication network 600A with the printing system 300D via the interface system 310D.

The network devices 300 can be provided as any type of conventional network devices, including one or more server systems 300A, 300B, memory systems 300C, printing systems 300D, and/or workstations 300N as illustrated in FIG. 4, and are configured to perform at least one preselected function. The server systems 300A, 300B typically include one or more computer systems, such as personal computer systems, and are employed to manage network resources. For example, the server system 300A can comprise a file server system for storing files to a mass storage system, such as the memory system 300C; whereas, the server system 300B can be a print server system for managing one or more printing systems, such as the printing system 300D.

Similarly, the memory system 300C can be configured to store and provide information, including data files, instruction code, and other types of information. Preferably comprising a non-volatile memory system, the memory system 300C can be provided as any conventional type of mass memory system, such as any electronic, magnetic, and/or optical storage media, without limitation. The printing system 300D likewise can include any kind of conventional printing system and is configured to print information on paper.

The workstation 300N typically is provided as a conventional single-user computer system, such as personal computer system, and includes at least one input system (not shown) and at least one output system (not shown). The input system can be provided in any suitable manner and normally includes a pushbutton device, such as a keyboard or a keypad, and/or a pointing device, such as a mouse or trackball. Typical output systems can include conventional video display systems, such as computer monitors, for visually presenting information and/or conventional audio systems, such as a soundcard and speakers, for audibly presenting information. As desired, the input system and the output system can be combined in the form of a touch screen.

Being configured to perform at least one preselected function, each network device 300 can be deemed to have malfunctioned, for example, when the network device 300 cannot perform one or more of the preselected functions. Such malfunctions can occur for many reasons, including improper power levels, inability to execute instructions, and/or inability for network devices 300 to communicate. Further, a malfunction in a first network device 300 may result in one or more other network devices 300 malfunctioning. If the server system 300B is configured to be a print server system for managing the printing system 300D, for example, a malfunction in the printing system 300D could be a consequence of a malfunction in the server system 300B.

In the absence of malfunctions, the network devices 300 preferably are configured to provide one or more status signals 410 as discussed above with reference to FIG. 1. The status signals 410 include information, such as an operational status and/or performance data, pertaining to the associated network device 300. Exemplary information provided with the status signals 410 can be information related to whether the associated network device 300 has experienced a malfunction. As illustrated in FIG. 4, the network devices 300 can respectively provide the status signals 410 to the communication network 600A, which, in turn, is configured to communicate the status signals 410 to the network management system 200A. Although each network device 300 is shown and described as being configured to provide the status signals 410 for purposes of illustration, it is understood that the network system 500A can include one or more network devices 300 that are not configured to provide the status signals 410.

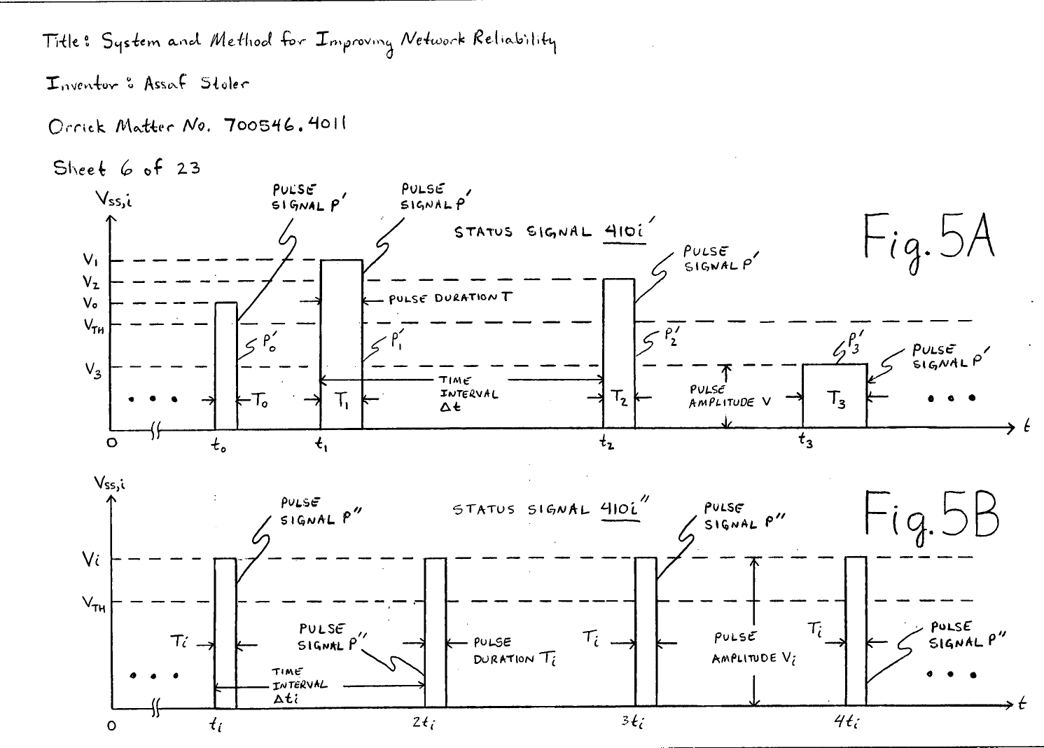

The status signals 410 can be provided as any type of signals that are suitable for communicating information that pertains to the associated network device 300. For example, each status signal 410 preferably comprises series of voltage and/or current pulse signals P′ as illustrated in FIG. 5A. The pulse signals P′ can be formed with any shape waveform, which can be substantially uniform and/or differ among the pulse signals P″, as desired. Stated somewhat differently, each pulse signal P′ can have a preselected pulse amplitude V and a preselected pulse duration T and can be initiated at a predetermined pulse time t such that a predetermined time interval Δt between successive pulse signals P′ can comprise any suitable time interval. Further, the status signals 410 for each network device 300 can differ, and/or two or more network devices 300 can provide status signals 410 that are substantially the same.

FIG. 5A illustrates an exemplary timing diagram of a selected status signal 410i′ provided by an associated network device 300 (shown in FIG. 4). The status signal 410i′ comprises a series of non-uniform voltage pulse signals P″, and four selected pulse signals P₀′, P₁′, P₂′, and P₃′ of the status signal 410i′ are shown in FIG. 5A. Pulse signal P₀′, for example, is shown as beginning substantially at a time t₀ and has a duration T₀. Approximately at time t₁, pulse signal P₁′ likewise begins with a duration T₁; whereas, pulse signals P₂′, P₃′ respectively begin substantially at times t₂, t₃ and have durations T₂, T₃. The pulse durations T₀, T₁, T₂, and T₃ preferably are sufficient to convey the information pertaining to the associated network device 300 to the network management system 200A (shown in FIG. 4). Although illustrated in FIG. 5A as having the four selected pulse signals P₀′, P₁′, P₂′, and P₃′, the status signal 410′ can comprise any suitable number of pulse signals P″, and the number of pulse signals P′ can depend upon whether the associated network device 300 malfunctions. Further, two or more of the pulse signals P′ can be substantially uniform and/or share at least one common pulse characteristic, such as a common pulse amplitude V and/or a common pulse duration T, even though each pulse signal P₀′, P₁′, P₂′, and P₃′ is shown and described herein as being substantially non-uniform for purposes of illustration.

As desired, the time interval Δt between two or more successive pulse signals P′ likewise can be substantially uniform. The time intervals Δt between successive pulse signals P′ preferably are substantially within a predetermined range of time intervals. Typically being less than or substantially equal to sixty seconds (60 sec.), each time interval Δt can comprise any predetermined amount of time and preferably is within a range between approximately one second (1 sec.) and fifteen seconds (15 sec.), inclusively. Each time interval Δt can be within any selected range of time intervals, including, for example, any five-second (5 sec.) range, such as the time range from three seconds (3 sec.) to eight seconds (8 sec.), between substantially one second (1 sec.) and sixty seconds (60 sec.). For selected network devices 300, time intervals Δt in excess of sixty seconds (60 sec.) may be appropriate.

The pulse signals P₀′, P₁′, P₂′, and P₃′ also are provided with preselected pulse amplitudes V₀, V₁, V₂, and V₃, respectively, as shown in FIG. 5A. Being illustrated as voltage potentials, the pulse amplitudes V₀, V₁, V₂, and V₃ each can comprise any suitable amplitude. Groups of pulse signals P′ likewise can be defined. The pulse signals P″, for instance, can be divided into substantially two groups: a first group (not shown) that comprises the pulse signals P′ having pulse amplitudes V that are greater than a threshold amplitude V_{TH}; and a second group (not shown) that includes any pulse signals P′ with a pulse amplitude V that is less than the threshold amplitude V_{TH}. As desired, any pulse signals P′ with pulse amplitudes V that are substantially equal to the threshold amplitude V_{TH} can be assigned to the first group or the second group.

The pulse signals P′ can comprise any type of logic signal, such as a transistor-transistor logic (TTL) signal or an emitter-coupled logic (ECL) signal, and can have any number of distinct logic levels, preferably at least two logic levels, such as a low logic level or a high logic level. The high logic level can comprise any voltage level, such as 1VDC, 3.3VDC, or 5VDC, that is greater than the low logic level, which typically is associated substantially with ground potential (0VDC). The threshold amplitude V_{TH} can comprise a dividing line between the high logic level and the low logic level.

Thereby, if the pulse amplitude V of a selected pulse signal P′ is less than the threshold amplitude V_{TH}, the selected pulse signal P′ can be associated with the low logic level; otherwise, the selected pulse signal P′ can be associated with the high logic level. Similarly, if one or more pulse signals P′ are omitted from the status signal 410i′, the omitted pulse signals P′ comprise pulse signals P′ with a pulse amplitude V that is substantially equal to zero and that is less than the threshold amplitude V_{TH}. The omitted pulse signals P′ thereby can be associated with the low logic level and can be included in the second group of pulse signals P′ in the manner discussed above.

As illustrated in FIG. 5A, the pulse signal P₀′ can be included in the first group of pulse signals P′ and can be associated with the high logic level because the pulse amplitude V₀ is greater than the threshold amplitude V_{TH}. The pulse amplitudes V₁, V₂ are greater than the threshold amplitude V_{TH} such that the pulse signals P₁′, P₂′ likewise are included with the first group of pulse signals P′ and associated with the high logic level. Although the pulse amplitudes V₀, V₁, and V₂ can vary among the pulse signals P₀′, P₁′, and P₂′, each of the pulse signals P₀′, P₁′, and P₂′ are included in the first group of pulse signals P′ and can be associated with the high logic level. The pulse signal P₃′, in contrast, is in the second group of pulse signals P′ and associated with the low logic level because the pulse amplitude V₃ is less than the threshold amplitude V_{TH}.

Therefore, if the first and second groups of pulse signals P′ respectively represent the absence and presence of a malfunction in the associated network device 300, the status signal 410i′ of FIG. 5A provides no indication that the associated network device 300 has malfunctioned prior to time t₂ because the pulse signals P₀′, P₁′, and P₂′ each are associated with the first group. The status signal 410i′ likewise indicates that the associated network device 300 has malfunctioned after time t₂ because the pulse signal P₃′ is associated with the second group of pulse signals P″. Although illustrated and described as being respectively associated with the high and low logic levels, the first and second groups of pulse signals P′ each can be associated with any logic level such that the logic level of the first group of pulse signals P′ is distinguishable from the logic level of the second group of pulse signals P″. For example, the pulse signals P′ in the first group can be associated with the low logic level; whereas, the second group of pulse signals P′ can have the high logic level.

Stated somewhat differently, the status signal 410i′ can be said to include at least two signal states, which preferably are distinguishable. The signal states, as desired, can include a first signal state and a second signal state and can be substantially analogous to the groups of pulse signals P′ discussed above. For example, the second signal state can be associated with the pulse signals P′ in the second group and can indicate a malfunction in the associated network device 300; otherwise, the status signal 410i′ can be associated with the first signal state. In the first signal state, the status signal 410i′ indicates that the associated network device 300 has not malfunctioned in the manner discussed above.

As desired, each of the pulse signals P′ in the status signal 410′ can be substantially uniform in amplitude, duration, and/or period as long as a malfunction has not occurred in the network device 300. FIG. 5B illustrates an exemplary timing diagram of a selected status signal 410i″ that comprises a series of pulse signals P″ that are substantially uniform in amplitude, duration, and period. Although four selected pulse signals P″ are shown in FIG. 5B for purposes of illustration, the status signal 410″ can comprise any suitable number of pulse signals P″, which number can depend upon whether the associated network device 300 (shown in FIG. 4) malfunctions. Each of the pulse signals P″ has a preselected pulse amplitude Vᵢ and a preselected pulse duration Tᵢ. Preferably being substantially equal, the amplitudes Vᵢ of the pulse signals P″ can be provided in the manner discussed in more detail above with regard to the preselected pulse amplitude V (shown in FIG. 5A) and preferably are greater than a threshold amplitude V_{TH} as long as the network device 300 has not malfunctioned. Similarly, the durations Tᵢ of the pulse signals P″ are substantially equal and can be provided in the manner discussed above with reference to the preselected pulse duration T (shown in FIG. 5A).

The pulse signals P″ each preferably are initiated such that a predetermined time interval Δtᵢ between successive pulse signals P″ is substantially equal for each successive pair of pulse signals P″ in the status signal 410″. The time intervals Δtᵢ between successive pulse signals P′ preferably are substantially within a predetermined range of time intervals, including any of the predetermined ranges discussed in more detail above with reference to FIG. 5A. If the time interval Δtᵢ between successive pulse signals P″ is substantially equal to a time tᵢ illustrated in FIG. 5B, each pulse signal P″ thereby can be initiated at a predetermined pulse time that is substantially equal to an integer multiple of the pulse time tᵢ.

In the manner discussed in more detail above with reference to FIG. 5A, groups of pulse signals P″ can be defined. For example, a first group (not shown) can comprise the pulse signals P″ with amplitudes Vᵢ that are greater than or substantially equal to the threshold amplitude V_{TH}; whereas, a second group (not shown) can include any pulse signals P″ having amplitudes Vᵢ that are less than the threshold amplitude V_{TH}. Each group of pulse signals P″ can be associated with a logic level in the manner discussed above. Further, any omitted pulse signals P″ can be associated with the logic level of the second group as discussed in more detail above. The absence or presence of a malfunction in the network device 300 thereby can be indicated by whether a selected pulse signal P″ is associated with the first group of pulse signals P″ or the second groups of pulse signals P″, respectively.

FIG. 6 is an exemplary timing diagram illustrating status signals 410A-N provided by the network devices 300A-N (shown in FIG. 4) of the network system 500A (shown in FIG. 4). Each of the status signals 410A-N comprise a series of voltage pulse signals P_{A}-P_{N} as shown in FIG. 6 and can be provided in the manner discussed in more detail above with regard to the status signal 410i′ (shown in FIG. 5A) and/or the status signal 410i″ (shown in FIG. 5B). For example, the status signal 410A is illustrated as comprising a series of substantially uniform pulse signals P_{A}, each having a preselected pulse amplitude V_{A} and a preselected pulse duration T_{A}. The status signals 410B, 410C likewise are respectively shown as series of substantially uniform pulse signals P_{B}, P_{C} with preselected pulse amplitudes V_{B}, V_{C} and preselected pulse durations T_{B}, T_{C}. Similarly, as illustrated in FIG. 6, the status signal 410D can be a series of pulse signals P_{D}; whereas, the status signal 410N can include a series of pulse signals P_{N}.

The pulse signals P_{D}, P_{N} in each series can be substantially uniform and can have preselected pulse amplitudes V_{D}, V_{N} and preselected pulse durations T_{D}, T_{N} as shown in FIG. 6. For purposes of the present example, each of the pulse amplitudes V_{A}-V_{N} is presumed to be greater than, or substantially equal to, the respective threshold amplitudes V_{TH} (shown in FIGS. 5A-B). Thereby, in the manner discussed in more detail above with reference to FIGS. 5A-B, the presence of the pulse signals P_{A}-P_{N} is an indication that the associated network devices 300A-N are not malfunctioning; whereas, a malfunction is indicated in one or more of the network devices 300A-N by the unexpected absence of the pulse signals P_{A}-P_{N}.

In the manner discussed in more detail above with reference to FIGS. 5A-B, the status signals 410A-N each can be initiated at a predetermined pulse time t_{A}-t_{N} such that a predetermined time interval Δt_{A}-Δt_{N} between successive pulse signals P_{A}-P_{N} can comprise any suitable time interval. The pulse times t_{A}-t_{N} for the pulse signals P_{A}-P_{N} can be substantially the same and/or differ for each status signal 410A-N such that each pulse signal P_{A}-P_{N} is temporally separate and/or two or more pulse signals P_{A}-P_{N} at least partially coincide and/or overlap in time. For example, the pulse signals P_{A}, P_{B} as shown in FIG. 6 are temporally separate because each pulse signal P_{B} is initiated after the preceding pulse signal P_{A} has concluded. In contrast, each of the pulse signals P_{B}, P_{D} are illustrated as being substantially coincident. The pulse signals P_{A}-P_{N} of two or more status signals 410A-N may be substantially coincident when the associated network devices 300 are configured to perform at least one related function. In this example, for instance, the server system 300B can be configured as a print server system for managing the printing system 300D.

The time interval Δt_{A}-Δt_{N} likewise can be substantially uniform and/or differ between successive pulse signals P_{A}-P_{N} and/or for each status signal 410A-N, as desired. Each status signal 410A-N is shown in FIG. 6 as having substantially uniform time intervals Δt_{A}-Δt_{N} between successive pulse signals P_{A}-P_{N}. The illustrated time intervals Δt_{A}-Δt_{N}, however, can differ among the status signals 410A-N. Although the time intervals Δt_{A}, Δt_{B} of the status signals 410A, 410B are substantially equal in FIG. 6, the time interval Δt_{C} is shown as being greater than the time interval Δt_{A}. Preferably, the time interval Δt_{A}-Δt_{N} are substantially within a predetermined range of time intervals, including any of the predetermined ranges discussed in more detail above with reference to FIG. 5A.

As desired, the status signals 410A-N can be divided into a plurality of time divisions, such as one or more system periods T_{S} as illustrated in FIG. 6. Each system period T_{S} comprises a time duration, which can be substantially uniform and/or differ among the system periods T_{S}. The duration of the system periods T_{S} can be determined in accordance with any suitable criteria and preferably is substantially within a predetermined range of time durations, including any of the predetermined ranges discussed in more detail above with reference to FIG. 5A. For example, the duration of the system periods T_{S} can comprise a predetermined time interval, such as a predetermined time interval Δt_{A}, between successive pulse signals P_{A}-P_{N} in one or more of the status signals 410A-N and/or a predetermined time interval during which substantially all of the network devices 300 are configured to provide at least one pulse signal P_{A}-P_{N}. Although the time duration of the system period T_{S} can comprise any suitable time duration, the system period T_{S} is shown and described with reference to FIG. 6 as being substantially equal to the time interval Δt_{A} between successive pulse signals P_{A} in the status signal 410A for purposes of illustration.

Each system period T_{S} can be initiated at any suitable time, such as a predetermined system period time t_{S}. As desired, the period time t_{S} can substantially correspond with one or more of the pulse times t_{A}-t_{N}. If the durations of the system periods T_{S} are substantially uniform as shown in FIG. 6, each system period T_{S} can be initiated at a predetermined period time that is substantially equal to an integer multiple of the period time t_{S}. For purposes of illustration, the pulse times t_{A}-t_{N} are shown and described with reference to FIG. 6 as temporal offsets from the period times t_{S} for each system period T_{S}.

During the first system period T_{S} beginning at the period time t_{S}, the status signal 410A of FIG. 6 includes the pulse signal P_{A}. The pulse signal P_{A} is initiated at the time t_{S}+t_{A}, which occurs the pulse time t_{A} after the period time t_{S}. In other words, the time t_{S}+t_{A} substantially comprises a sum of the pulse time t_{A} and the period time t_{S}. The pulse signal P_{A}, once initiated, substantially maintains the pulse amplitude V_{A} for the time interval Δt_{A}. Similarly, the status signal 410B is shown as initiating the pulse signal P_{B} at the time t_{S}+t_{B} and substantially maintaining the pulse amplitude V_{B} for the time interval Δt_{B}. The status signals 410C, 410D likewise respectively include the pulse signals P_{C}, P_{D}.

Being initiated at the time t_{S}+t_{C}, the pulse signal P_{C} substantially maintains the pulse amplitude V_{C} for the time interval Δt_{C}; whereas, pulse signal P_{D} is initiated at the time t_{S}+t_{D} and substantially maintains the pulse amplitude V_{D} for the time interval Δt_{D}. The status signal 410N is shown as initiating the pulse signal P_{N} at the time t_{S}+t_{N} and substantially maintaining the pulse amplitude V_{N} for the time interval Δt_{N}. In the manner discussed in more detail above with reference to FIGS. 5A-B, the status signals 410A-N thereby provide an indication that the associated network devices 300A-N are not malfunctioning because none of the pulse signals P_{A}-P_{N} have been omitted during the first system period T_{S}.

The status signal 410A shown in FIG. 6 also includes the pulse signal P_{A} in the second system period T_{S} that begins at the period time 2t_{S}. The pulse signal P_{A} is provided in the manner discussed above with regard to the first system period T_{S} and is initiated at the time 2t_{S}+t_{A}. Being provided in the manner described above, the status signals 410B, 410D, and 410N likewise initiate the pulse signals P_{B}, P_{D}, and P_{N} at the times 2t_{S}+t_{B}, 2t_{S}+t_{D}, and 2t_{S}+t_{N}, respectively. The status signals 410A, 410B, 410D, and 410N include the pulse signals P_{A}, P_{B}, P_{D}, and P_{N} because, as previously discussed, the time intervals Δt_{A}, Δt_{B}, Δt_{D}, Δt_{N} of the status signals 410A, 410B, 410D, and 410N as shown in FIG. 6 are substantially equal to the system period T_{S}.

The time interval Δt_{C} of the status signal 410C, in contrast, is shown as being greater than the system period T_{S}. The status signal 410C therefore does not include the pulse signal P_{C} during the second system period T_{S}. Since the pulse signal P_{C} is not expected during the second system period T_{S}, the pulse signal P_{C} has not been omitted from the status signal 410C. As such, the absence of the pulse signal P_{C} from the status signal 410C during the second system period Ts does not comprise an indication that the memory system 300C is malfunctioning. In the manner discussed in more detail above, the status signals 410A-N thereby do not provide any indication that the associated network devices 300A-N are malfunctioning because none of the pulse signals P_{A}-P_{N} have been omitted during the second system period T_{S}.

In the third system period T_{S} beginning at the period time 3t_{S}, the illustrated status signals 410A-N include the pulse signals P_{A}-P_{N}, each of the pulse signals P_{A}-P_{N} being provided in the manner discussed above with regard to the first system period T_{S}. As shown in FIG. 6, the pulse signal P_{A} is initiated at the time 3t_{S}+t_{A}; whereas, the pulse signals P_{B}, P_{C} are initiated at the times 3t_{S}+t_{B}, 3t_{S}+t_{C}, respectively. The pulse signal P_{N} similarly is initiated at the time 3t_{S}+t_{N}. In the manner discussed in more detail above, the status signals 410A-N thereby provide an indication that the associated network devices 300A-N are not malfunctioning because none of the pulse signals P_{A}-P_{N} have been omitted during the third system period T_{S}.

Turning to the fourth system period T_{S} that begins at the period time 4t_{S}, the status signal 410A is not shown as including the pulse signal P_{A}. Since the time interval Δt_{A} of the status signal 410A as illustrated in FIG. 6 is substantially equal to the system period T_{S}, however, the server system 300A is expected to include the pulse signal P_{A} in the status signal 410A during the fourth system period T_{S}. In the manner discussed in more detail above, the status signal 410A thereby indicates that the server system 300A has experienced a malfunction and that the malfunction occurred between the time 3t_{S}+t_{A} and the time 4t_{S}+t_{A}.

As discussed above with reference to the second system period T_{S}, the status signals 410B, 410D, and 410N include the pulse signals P_{B}, P_{D}, and P_{N}, which are provided in the manner discussed above and which are respectively initiated at the times 4t_{S}+t_{B}, 4t_{S}+t_{D}, and 4t_{S}+t_{N}, as shown in FIG. 6; whereas, the status signal 410C does not include the pulse signal P_{C} during the fourth system period T_{S}. Since the pulse signal P_{C} is not expected during the fourth system period T_{S}, the absence of the pulse signal P_{C} from the status signal 410C does not comprise an indication that the memory system 300C is malfunctioning. In the manner discussed in more detail above, the status signals 410B-N thereby do not provide any indication that the associated network devices 300B-N are malfunctioning because none of the pulse signals P_{B}-P_{N} have been omitted during the fourth system period T_{S}. The status signals 410A-N provided during the fourth system period T_{S} indicate that the server system 300A has malfunctioned and that the network devices 300B-N are not malfunctioning.

The malfunction in the server system 300A likely can be detected and remedied such that the server system 300A can be operable at a future time. As shown in FIG. 6, the status signal 410A includes the pulse signal P_{A} during the m^{th} system period T_{S} that begins at the period time mt_{S}. The illustrated status signals 410B-N likewise include the pulse signals P_{B}-P_{N}, and each of the pulse signals P_{A}-P_{N} are provided in the manner discussed above. As shown in FIG. 6, the pulse signal P_{A} is initiated at the time mt_{S}+t_{A}; whereas, the pulse signals P_{B}, P_{C} are initiated at the times mt_{S}+t_{B}, mt_{S}+t_{C}, respectively. The pulse signal P_{N} similarly is initiated at the time mt_{S}+t_{N}. In the manner discussed in more detail above, the status signals 410A-N thereby provide an indication that the associated network devices 300A-N, including the server system 300A, are not malfunctioning because none of the pulse signals P_{A}-P_{N} have been omitted during the m^{th} system period T_{S}.

The network devices 300A-N can provide the status signals 410A-N in any suitable manner. Returning to FIG. 4, for example, the network devices 300 can include timing systems 320 for providing the status signals 410. The timing systems 320 can comprise any suitable type of timing system for providing the status signals 410 and can have one or more hardware components and/or software components. One illustrative timing system 320 is a conventional counter system. Although each network device 300A-N is shown and described as having a timing system 320A-N for purposes of illustration, the network system 500A can include one or more network devices 300 that do not include a timing systems 320 and/or that are not configured to provide the status signals 410 in the manner discussed above.

Two or more network devices 300 can be associated with substantially separate timing system 320, as illustrated in FIG. 4, and/or can be associated with a common timing system 320. The common timing system 320 can be configured to provide substantially separate status signals 410 for each of the selected network devices 300 and/or to provide at least one composite status signal 410 for two or more of the selected network devices 300. Being disposed substantially within, and/or separate from, at least one of the selected network devices 300 in the manner discussed in more detail above with reference to the interface systems 310, the common timing system 320 might be appropriate, for example, when the selected network devices 300 perform at least one related function. Exemplary selected network devices 300 that perform at least one related function include the server system 300B being configured as a print server system for managing the printing system 300D. Since a malfunction in the server system 300B, the printing system 300D, or both can disrupt the associated printing function, the common timing system 320 can be configured to provide a status signal 420 that is related to a status of the associated printing function.

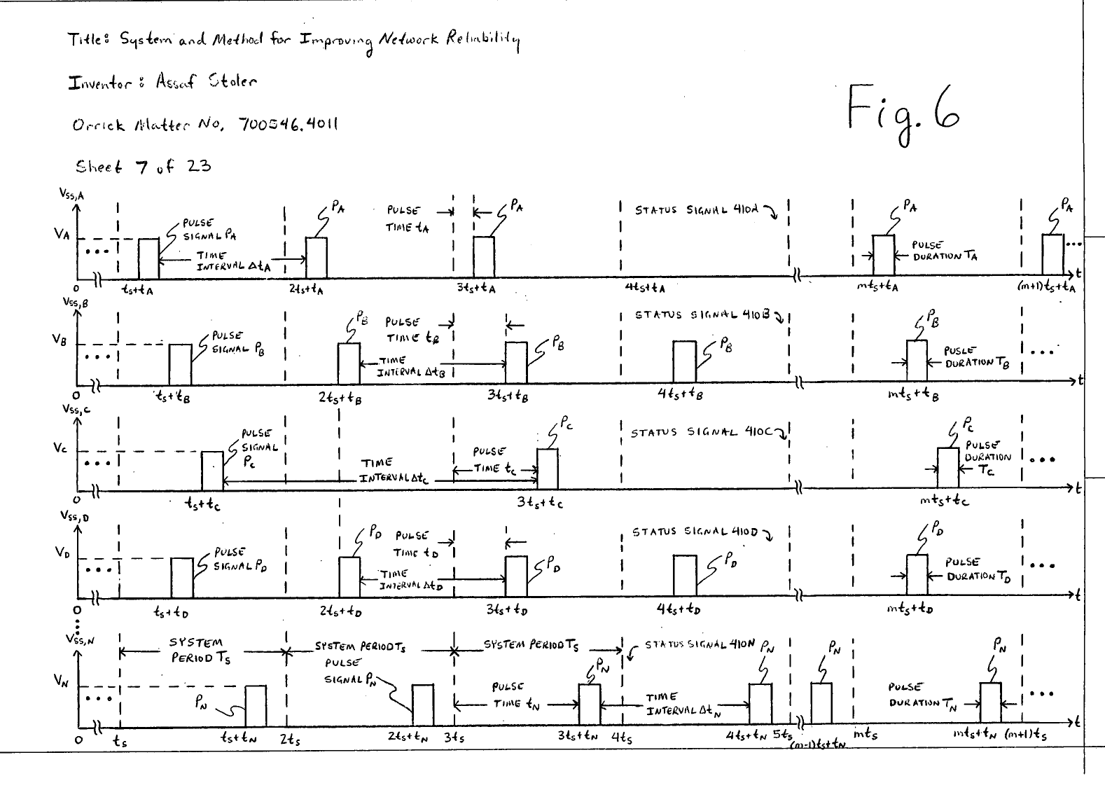

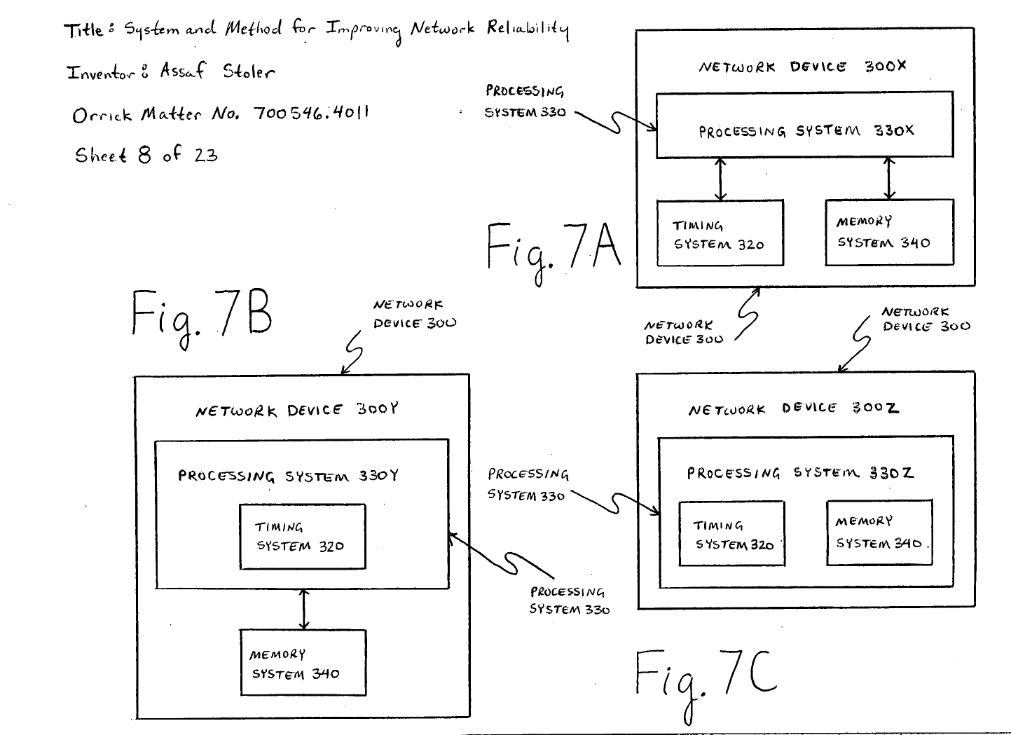

Turning to FIGS. 7A-C, each of the illustrated network devices 300 are shown as including a processing system 330 and a memory system 340. Being configured to perform, and/or control the performance or, at least one of the preselected functions performed by the network device 300, the processing system 330 can be provided as any suitable type of conventional processing system, without limitation, such as one or more microprocessors (pPs), central processing units (CPUs), digital signal processors (DSPs), field-programmable gate arrays (FPGAs), and/or application-specific integrated circuits (ASICs) of any kind. If the network device 300 experiences a malfunction, the processing system 330 likewise can process information related to appropriate corrective action for remedying the malfunction substantially in accordance with any instruction for implementing the corrective action as provided by the network management system 200 (shown in FIG. 4) via the control signal 420 (shown in FIG. 4).

Being coupled with, and configured to communicate with, the processing system 330, the memory system 340 is configured to store and provide information, including instruction code, such as software or firmware, intermediate calculation results, and other information associated with the processing system 330 and/or the network device 300. The memory system 340 likewise can include performance data related to the current and/or historical operational status of the network device 300, as desired. Preferably comprising a non-volatile memory system, the memory system 340 can comprise any suitable type of conventional memory system, such as any electronic, magnetic, and/or optical storage media, without limitation. For example, exemplary storage media can include one or more static random access memories (SRAMs), dynamic random access memories (DRAMs), electrically-erasable programmable read-only memories (EEPROMs), FLASH memories, hard drives (HDDs), compact disks (CDs), and/or digital video disks (DVDs) of any kind.

As desired, the processing system 330 can be configured to provide the status signal 410 (shown in FIG. 4) for the associated network device 300. The processing system 330 can provide the status signal 410 in any suitable manner, including in the manner discussed in more detail above with reference to the timing system 320 illustrated in FIG. 4. For example, the processing system 330 can provide the status signal 410 by executing a software algorithm stored in the memory system 340 and/or periodically polling the associated network device 300 to determine whether the preselected functions are being performed. As illustrated in the network device 300X of FIG. 7A, the timing system 320 can be separate from the processing system 330X; whereas, the timing system 320 is shown as being disposed substantially within the processing system 330Y in the network device 300Y as illustrated in FIG. 7B. Further, the memory system 340 can be separate from the processing system the processing system 330Y as shown in FIG. 7B and/or disposed substantially within the processing system 330Z as shown in the network device 300Z shown in FIG. 7C.

The network management system 200A, being is configured to detect and remedy malfunctions in the network devices 300, can receive the status signals 410 from the network devices 300 in any suitable manner. Returning to FIG. 4, the network management system 200 is illustrated as being configured to receive the status signals 410 from the network devices 300 via the network system 500A. The network management system 200 can be coupled with the network system 500A in any conventional manner, including directly or indirectly, for example, via an interface system 210 as shown in FIG. 4. Being provided in the manner set forth above with reference to the interface systems 310, the interface system 210 is configured to facilitate the exchange of the communications signals 400 between the network management system 200A and the network system 500A and can be disposed substantially within, or separate from, the network management system 200A.

The network system 500A likewise can include an interface system (not shown). If the network management system 200A is coupled with the network system 500A via the communication network 600A as illustrated in FIG. 4, for example, an interface systems 610 can be provided to couple the network management system 200A and the communication network 600A. Preferably comprising a conventional communication interface system, the interface system can include one or more hardware components, such as a network hub with a predetermined number of communication ports, and/or one or more software components, such as a device driver in the manner set for above with regard to the interface system 610. The interface system is configured to facilitate the exchange of the communications signals 400 between the network management system 200A and the network system 500A and can be disposed substantially within, or separate from, the network system 500A.

Upon receiving the status signals 410, the network management system 200A can process the status signals 410 in any suitable manner to determine whether a malfunction has occurred in one or more of the network devices 300. The network management system 200A likewise is configured to provide suitable control signals 420 for remedying any malfunctions when the status signals 410 are processed. For example, the network management system 200A can include a signal processing system 220 for processing the status signals 410 and a signal providing system 230 for providing the control signals 420 as shown in FIG. 4. Having one or more hardware components and/or software components, the signal processing system 220 can comprise any suitable type of signal processing system for receiving and processing the status signals 410; whereas, the signal providing system 230 can be provided as any suitable type of signal providing system for providing the control signals 420. Although shown and described as being substantially separate for purposes of illustration, the signal processing system 220 and the signal providing system 230 can be at least partially combined and/or can share one or more components, as desired.

Being configured to determine whether any of the associated status signals 410 has indicated a malfunction in one or more of the associated network devices 300, the signal processing system 220 can receive and process the status signals 410 in any suitable manner. As illustrated, in FIG. 4, for example, the signal processing system 220 can provide enable signals 430 for communicating malfunction information that pertains to whether such a malfunction has been indicated by any of the associated status signals 410. The enable signals 430 can be provided as any type of signals that are suitable for communicating the malfunction information and can be provided with any suitable shape waveform. For example, each enable signal 430 can have at least two signal states in the manner discussed in more detail above with reference to the status signal 410i′. Preferably comprising distinguishable signal states, the signal states of the enable signals 430 can include a first signal state that is associated with the absence of a malfunction indication in the associated network devices 300 and a second signal state that is associated with the presence of a malfunction indication.

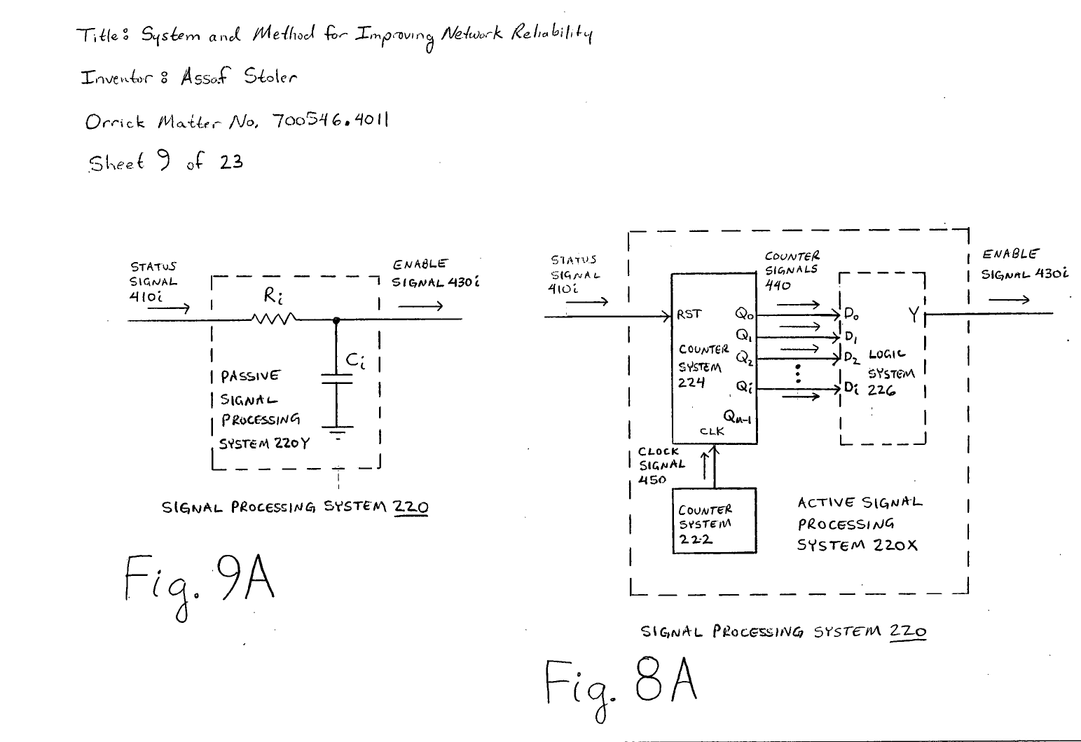

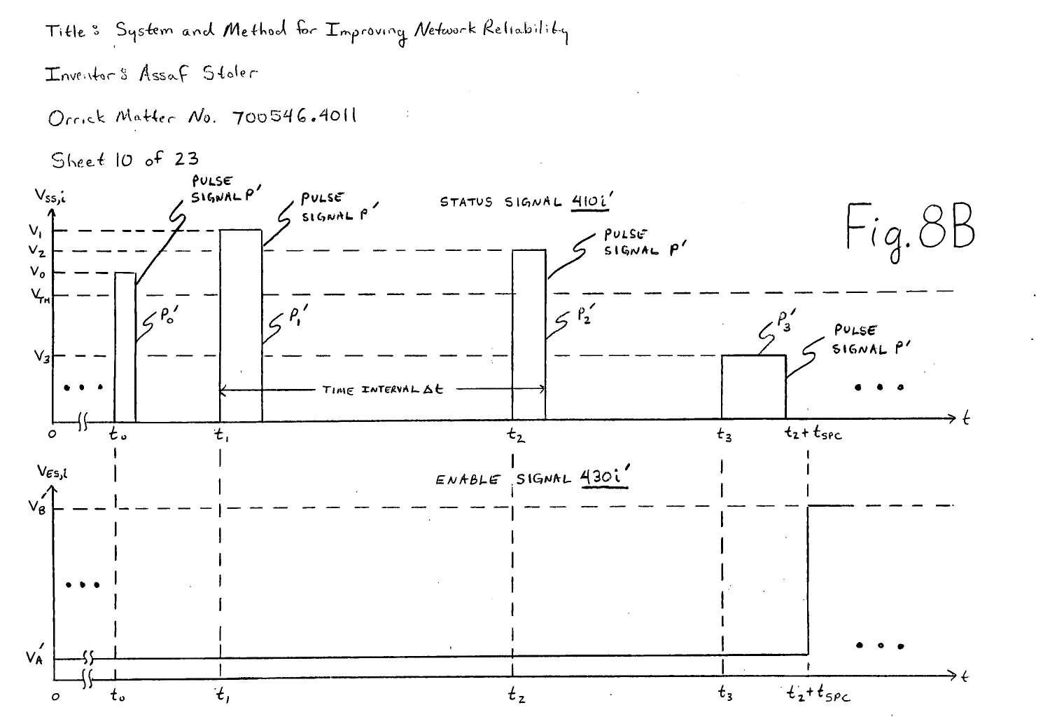

If provided with one or more hardware components, the signal processing system 220 can include at least one active hardware component and/or at least one passive hardware component. An exemplary active signal processing system 220X is shown in FIG. 8A. Being configured to receive a selected status signal 410i provided by an associated network device 300 (shown in FIG. 4) and to provide an enable signal 430i for communicating malfunction information that pertains to the associated network device 300, the signal processing system 220X is illustrated as including a clock system 222 and a counter system 224. The clock system 222 can be any type of conventional clock system that is suitable for providing a clock signal 450 having a predetermined frequency. The counter system 224 similarly can comprise any type of conventional M-bit counter system, can receive the status signal 410i and the clock signal 450, and is configured to provide one or more counter signals 440, such as one or more of counter output signals Q₀-Q_{M-1} and/or a ripple carry output signal (not shown).

As shown in FIG. 8A, the status signal 410i can be received via a reset input RST of the counter system 224; whereas, the clock system 222 is coupled with, and configured to provide the clock signal 450, to a clock input CLK of the counter system 224. The counter system 224 thereby is configured to increment (or decrement) with each clock cycle of the clock signal 450 until reset by the status signal 410i. As desired, the counter system 224 can provide the enable signal 430i substantially directly such as by including the ripple carry output signal among the counter signals 440. Stated somewhat differently, the enable signal 430i can be provided via a selected one of the counter signals 440.

The enable signal 430i likewise can comprise a combination of two or more selected counter signals 440. As illustrated in FIG. 8A, the counter system 224 can indirectly provide the enable signal 430i, for example, by being coupled with, and configured to communicate with a logic system 226. The logic system 226 can comprise any conventional type of logic system, such as a combinatorial and/or sequential logic system, for receiving the counter signals 440 and for providing the enable signal 430i. As shown in FIG. 8A, the logic system 226 can include one or more logic inputs D₀-D₁ for receiving some or substantially all of the counter output signals Q₀-Q_{M-1} of the counter system 224 and at least one logic output Y for providing the enable signal 430i. The clock signal 450 can be provided to the logic system 226 such as by coupling the logic system 226 and the clock system 222 as desired. Although shown and described as being substantially separate for purposes of illustration, the counter system 224, the logic system 226, and/or the clock system can be integrated such as via one or more programmable logic arrays (PLAs), field-programmable gate arrays (FPGAs), and/or application-specific integrated circuits (ASICs) of any kind.

A preselected timing period t_{SPC} (shown in FIG. 8B) of the signal processing system 220X can be determined via a selection of the predetermined frequency of the clock signal 450 and/or the counter signals 440. For example, the timing period t_{SPC} can be increased by decreasing the predetermined frequency of the clock signal 450 and/or by increasing the number of counter output signals Q₀-Q_{M-1} considered by the logic system 226. The timing period t_{SPC} preferably is substantially within a predetermined range of time intervals, including any of the predetermined ranges discussed in more detail above with regard to the time intervals Δt (shown in FIG. 5A). The timing period t_{SPC} preferably is selected such that, absent an indication that the associated network device 300 has malfunctioned, the status signal 410i can reset the counter system 224 before the timing period t_{SPC} expires. When the status signal 410i includes an indication that the associated network device 300 has malfunctioned, the status signal 410i is not configured to reset the counter system 224 such that the timing period t_{SPC} is permitted to expire.

In the manner discussed above with reference to FIG. 4, the enable signal 430i preferably comprises at least two distinguishable signal states. A first signal state of the enable signal 430i is associated with the absence of a malfunction indication in the associated network device 300; whereas, the enable signal 430i also has a second signal state that is associated with the presence of a malfunction indication. In the manner discussed in more detail above with regard to the status signal 410i′; (shown in FIG. 5A), the enable signal 430i can comprise a logic signal having a high logic level and a low logic level, each being associated with one of the signal states. For purposes of illustration only, the first and second signal states of the enable signal 430i will be shown and described with reference to FIGS. 8A-B as being respectively associated with the low and high logic level.

The operation of the signal processing system 220X can be illustrated via the exemplary timing diagrams of FIG. 8B. The top timing diagram of FIG. 8B shows a status signal 410i′, which is provided, in relevant part, as discussed in more detail above with reference to FIG. 5A. The status signal 410i′ comprises a series of non-uniform voltage pulse signals P″, and four selected pulse signals P₀′, P₁′, P₂′, and P₃′ of the status signal 410i′ are shown in FIG. 8B. In the manner discussed in greater detail above, the pulse signals P₀′, P₁′, and P₂′ are included in a first group of pulse signals P′ and can be associated with a high logic level because the pulse amplitudes V₀, V₁, and V₂, respectively, are greater than a threshold amplitude V_{TH}; whereas, the pulse signal P₃′, in contrast, is in a second group of pulse signals P′ and associated with the low logic level because the pulse amplitude V₃ is less than the threshold amplitude V_{TH}. Therefore, if the first and second groups of pulse signals P′ respectively represent the absence and presence of a malfunction in the associated network device 300, the status signal 410i′ of FIG. 8B provides no indication that the associated network device 300 has malfunctioned prior to time t₂ because the pulse signals P₀′, P₁′, and P₂′ each are associated with the first group. The status signal 410i′ likewise indicates that the associated network device 300 has malfunctioned after time t₂ because the pulse signal P₃′ is associated with the second group of pulse signals P″.

Turning to the timing diagram of the enable signal 430i′ as shown in FIG. 8B, the enable signal 430i′ is illustrated as having the low logic level of the first signal state prior to time t₀. The low logic level is illustrated as being associated with a voltage level V_{A}′ in FIG. 8B. As the counter system 224 (shown in FIG. 8A) increments (or decrements) with each clock cycle of the clock signal 450 (shown in FIG. 8A), the logic system 226 (shown in FIG. 8A) receives the relevant counter signals 440 and determines whether the timing period t_{SPC} has expired. As long as the timing period t_{SPC} has not expired, the enable signal 430i′ maintains the first logic state and comprises the voltage level V_{A}′ of the low logic level. If the timing period t_{SPC} is permitted to expire, however, the enable signal 430i′ enters, and preferably can maintain, the second logic state, which is can be associated with a voltage level V_{B}′ of the high logic level as illustrated in FIG. 8B.

At time t₀, the status signal 410i′ provides the pulse signal P₀′ as shown in FIG. 8B. The pulse signal P₀′ is received by the reset input RST of the counter system 224 and is configured to reset the counter system 224. Once the counter system 224 is reset, the counter system 224 again begins to increment (or decrement) with each clock cycle of the clock signal 450. The enable signal 430i′ thereby can maintain the voltage level V_{A}′ of the first logic state until time t₀+t_{SPC} and will enter the second logic state unless the counter system 224 is again reset prior to the time t₀+t_{SPC}. The status signal 410i′ is illustrated as providing the pulse signal P₁′ at time t₁, which occurs before the time t₀+t_{SPC}. In the manner discussed above, the counter system 224 is reset by the pulse signal P₁′ such that the enable signal 430i′ can maintain the first logic state until time t₁+t_{SPC}. The pulse signal P₂′ is provided by the status signal 410i′ at time t₂ as shown in FIG. 8B. Since the time t₂ occurs prior to the time t₁+t_{SPC}, the counter system 224 is reset by the pulse signal P₂′ such that the enable signal 430i′ continues to maintain the first logic state in the manner discussed above. The enable signal 430i′ thereby can maintain the first logic state until time t₂+t_{SPC}.

The status signal 410i′ is shown as providing the pulse signal P₃′ at time t₃. Although the time t₃ precedes the time t₂+t_{SPC}, the pulse signal P₃′, in contrast to the pulse signals P₀′, P₁′, and P₂′, the pulse signal P₃′ is not configured to reset the counter system 224. Therefore, the counter system 224 continues to increment (or decrement) with each clock cycle of the clock signal 450 such that the enable signal 430i′ maintains the voltage level V_{A}′ of the first logic state until the time t₂+t_{SPC}. Since the status signal 410i′ does not provide a pulse signal P′ that is suitable for resetting the counter system 224 prior to the time t₂+t_{SPC}, the enable signal 430i′ enters the second logic state at the time t₂+t_{SPC}. Upon entering the second logic state, the enable signal 430i′ provides the voltage level V_{B}′ as shown in FIG. 8B.

As desired, the enable signal 430i′ can be configured to substantially maintain the second logic state pending contrary instruction, such as a reset signal (not shown) from the network management system 200A (shown in FIG. 4). For example, the signal processing system 220X (shown in FIG. 8A) can include a latch system (not shown), which may be separate from, and/or substantially disposed within, the logic system 226 (shown in FIG. 8A). Comprising any suitable type of conventional latch system, such as one or more latches and/or flip-flops, the latch system is configured to receive the enable signal 430i′ and to provide a modified enable signal (not shown). The modified enable signal substantially comprises the enable signal 430i′ when the enable signal 430i′ is in the first logic state. If the enable signal 430i′ enters the second logic state, however, the modified enable signal is configured to substantially maintain the second logic state of the enable signal 430i′ regardless of whether the enable signal 430i′ subsequently returns to the first logic state.

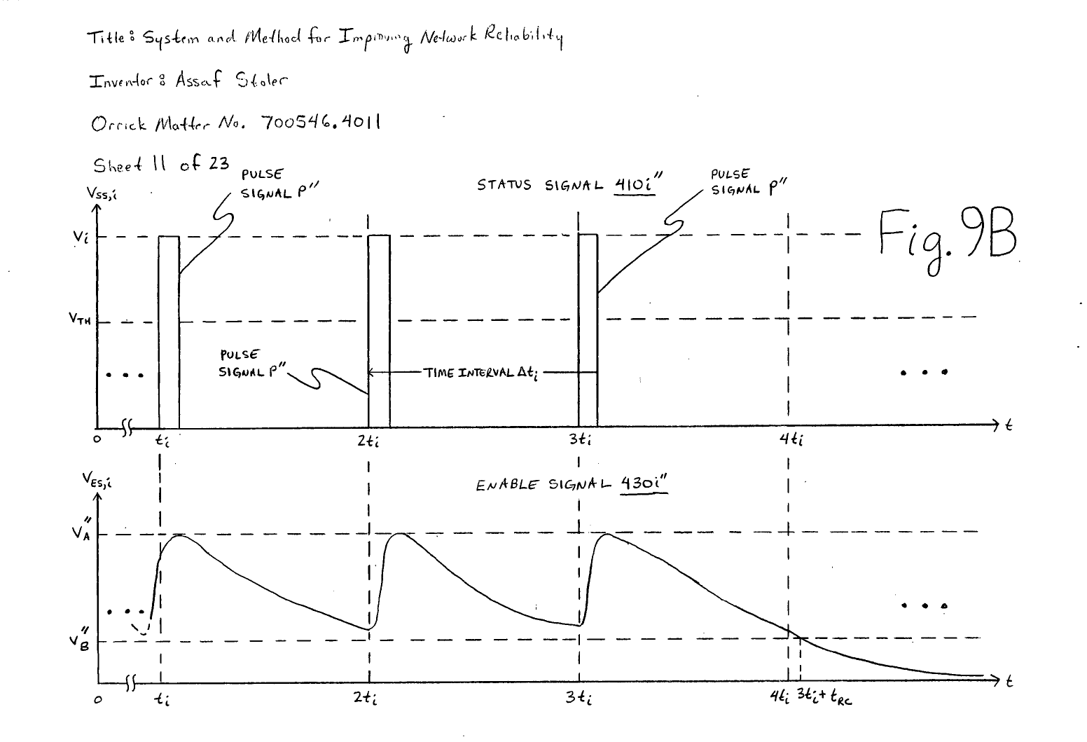

FIG. 9A shows an illustrative passive signal processing system 220Y. In the manner discussed above, the signal processing system 220Y is configured to receive a selected status signal 410i provided by an associated network device 300 (shown in FIG. 4) and to provide an enable signal 430i for communicating malfunction information that pertains to the associated network device 300. In the manner discussed above with reference to FIGS. 8A-B, the enable signal 430i preferably comprises at least two distinguishable signal states: a first signal state; and a second signal state. The first and second signal states of the enable signal 430i are associated with the absence and presence, respectively, of a malfunction indication in the associated network device 300.

The signal processing system 220Y has a preselected timing period t_{RC} (shown in FIG. 9B). In the manner discussed above with reference to the timing period t_{SPC} (shown in FIG. 8B), the timing period t_{RC} preferably is selected such that, absent an indication that the associated network device 300 has malfunctioned, the status signal 410i is configured to provide a pulse signal P″ (shown in FIG. 9B) before the timing period t_{RC} expires. When the status signal 410i includes an indication that the associated network device 300 has malfunctioned, the status signal 410i is not configured to the pulse signal P″ such that the timing period t_{RC} is permitted to expire. The timing period t_{SPC} can be determined via a selection of one or more components, such as passive components, and preferably is substantially within a predetermined range of time intervals, including any of the predetermined ranges discussed in more detail above with regard to the time intervals Δt (shown in FIG. 5A).

The signal processing system 220Y is illustrated in FIG. 9A as including a conventional RC network that comprises a resistor Ri and a capacitor Ci. The resistor Ri and the capacitor Ci each have first and second terminals. As shown in FIG. 9A, the first terminal of the resistor Ri is configured to receive the status signal 410i; whereas, the second terminal of the resistor Ri is coupled with the first terminal of the capacitor Ci and configured to provide the enable signal 430i. The second terminal of the capacitor Ci is illustrated as being coupled with a reference, such as a signal ground. The timing period t_{RC} can be provided as a time constant of the RC network, which can be determined in the conventional manner such as via an appropriate selection of values for the resistor Ri and the capacitor Ci. Although shown and described as comprising the resistor Ri and the capacitor Ci for purposes of illustration, the signal processing system 220Y can be provided via any suitable arrangement of appropriate discrete or integrated components of any kind.

As shown in FIG. 9A, the status signal 410i can be received via the resistor Ri such that the pulse signals P″ of the status signal 410i are configured to charge the capacitor Ci such that the enable signal 430i approaches approximately a selected voltage level V_{A}″ (shown in FIG. 9B). After each pulse signal P″, the capacitor Ci begins to discharge substantially in accordance with the timing constant of the RC network until recharged by a subsequent pulse signal P″. The voltage level of the status signal 410i thereby drops below the selected voltage level V_{A}″ as the capacitor Ci discharges. While greater than approximately a predetermined voltage level V_{B}″ (shown in FIG. 9B), the enable signal 430i can be associated with the first signal state; otherwise, the enable signal 430i can be associated with the second signal state.

FIG. 9B provides exemplary timing diagrams to illustrate the operation of the signal processing system 220Y. The top timing diagram of FIG. 9B shows a status signal 410i″, which is provided, in relevant part, as discussed in more detail above with reference to FIG. 5B. The status signal 410i″ comprises a series of substantially voltage pulse signals P″ each having a preselected pulse amplitude Vᵢ that preferably is greater than a threshold amplitude V_{TH} as long as the network device 300 has not malfunctioned and that preferably are initiated such that a predetermined time interval Δtᵢ between successive pulse signals P″. In the manner discussed in greater detail above, the pulse signals P″ of the status signal 410i″ can represent the absence of a malfunction in the associated network device 300 (shown in FIG. 4). At time 4tᵢ, however, the status signal 410i″ does not provide a pulse signal P″ and can provide an indication of the presence of a malfunction in the associated network device 300. Providing no indication of a malfunction prior to time 3tᵢ, the status signal 410i″ of FIG. 9B indicates that the associated network device 300 has malfunctioned after time 3tᵢ because the status signal 410i″ does not provide a pulse signal P″ at time 4tᵢ.

Turning to the timing diagram of the enable signal 430i″ as shown in FIG. 9B, the enable signal 430i″ is illustrated as having a voltage level that is greater than the voltage level V_{B}″ prior to time tᵢ. Although the capacitor Ci (shown in FIG. 9A) continues to discharge, the enable signal 430i″ remains in the first signal state and indicates the absence of a malfunction in the associated network device 300. At time to, the status signal 410i″ provides the pulse signal P″ as shown in FIG. 9B. The pulse signal P″ is provided to the capacitor Ci, charging the capacitor Ci such that the enable signal 430i″ approaches approximately the selected voltage level V_{A} and signifies that the presence of a malfunction in the associated network device 300 has not been indicated by the status signal 410i″. After the pulse signal P″, the capacitor Ci begins to discharge substantially in accordance with the timing constant of the RC network. The enable signal 430i″ thereby can maintain a voltage level that is greater than the voltage level V_{B}″, and remain in the first signal state, until time tᵢ+t_{RC} and will enter the second signal state unless the status signal 410i″ provides another pulse signal P″ prior to the time tᵢ+t_{RC}.

The status signal 410i″ is illustrated as providing a pulse signal P″ at time 2tᵢ, which occurs before the time tᵢ+t_{RC}. In the manner discussed above, the capacitor Ci thereby is again charged such that the enable signal 430i″ approaches approximately the selected voltage level V_{A}″ and can remain in the first signal state until time 2tᵢ+t_{RC}. Another pulse signal P″ is provided by the status signal 410i″ at time 3tᵢ as shown in FIG. 9B. Since the time 3tᵢ occurs prior to the time 2tᵢ+t_{RC}, the capacitor Ci is again charged such that the enable signal 430i″ continues to maintain the first signal state until time 3tᵢ+t_{RC} in the manner discussed above. The enable signal 430i″ thereby signifies that the status signal 410i″ has not indicated the presence of a malfunction in the associated network device 300 prior to time 3tᵢ.

The status signal 410i″ does not provide a pulse signal P″ at time 4tᵢ, as discussed above, indicating the presence of a malfunction in the associated network device 300. The capacitor Ci therefore is not recharged at time 4tᵢ and continues to discharge substantially in accordance with the timing constant of the RC network such that the voltage level of the enable signal 430i″ drops below the voltage level V_{B}″ at the time 3tᵢ+t_{RC}. Since the status signal 410i″ does not provide a pulse signal P″ that is suitable for recharging the capacitor Ci prior to the time 3tᵢ+t_{RC}, the enable signal 430i″ enters the second signal state at the time 3tᵢ+t_{RC}. Upon entering the second signal state, the enable signal 430i″ provides a voltage level that is less than the voltage level V_{B}′ as shown in FIG. 8B. Although shown and described as comprising the signal processing system 220X in FIG. 8A and the signal processing system 220Y in FIG. 9A for purposes of illustration, it is understood that the signal processing system 220 can comprise any type of signal processing system and is not limited to the illustrated embodiments.

In the manner discussed in more detail above with reference to the enable signal 430i′ (shown in FIG. 8B), the enable signal 430i″ can be configured to substantially maintain the second logic state pending contrary instruction. For example, the signal processing system 220Y (shown in FIG. 9A) can include a latch system (not shown) as set forth above. Comprising any suitable type of conventional latch system, such as one or more latches and/or flip-flops, the latch system is configured to receive the enable signal 430i″ and to provide a modified enable signal (not shown). The modified enable signal substantially comprises the enable signal 430i″ when the enable signal 430i″ is in the first signal state. If the enable signal 430i″ enters the second logic state, however, the modified enable signal is configured to substantially maintain the second signal state of the enable signal 430i″ regardless of whether the enable signal 430i″ subsequently returns to the first signal state.

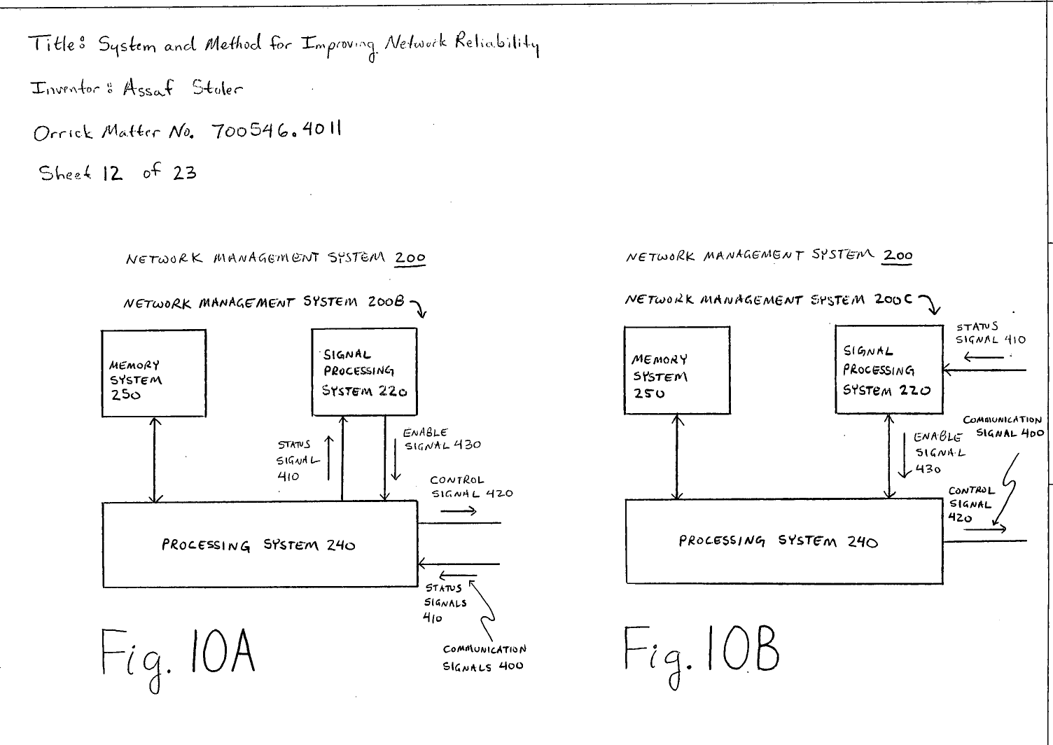

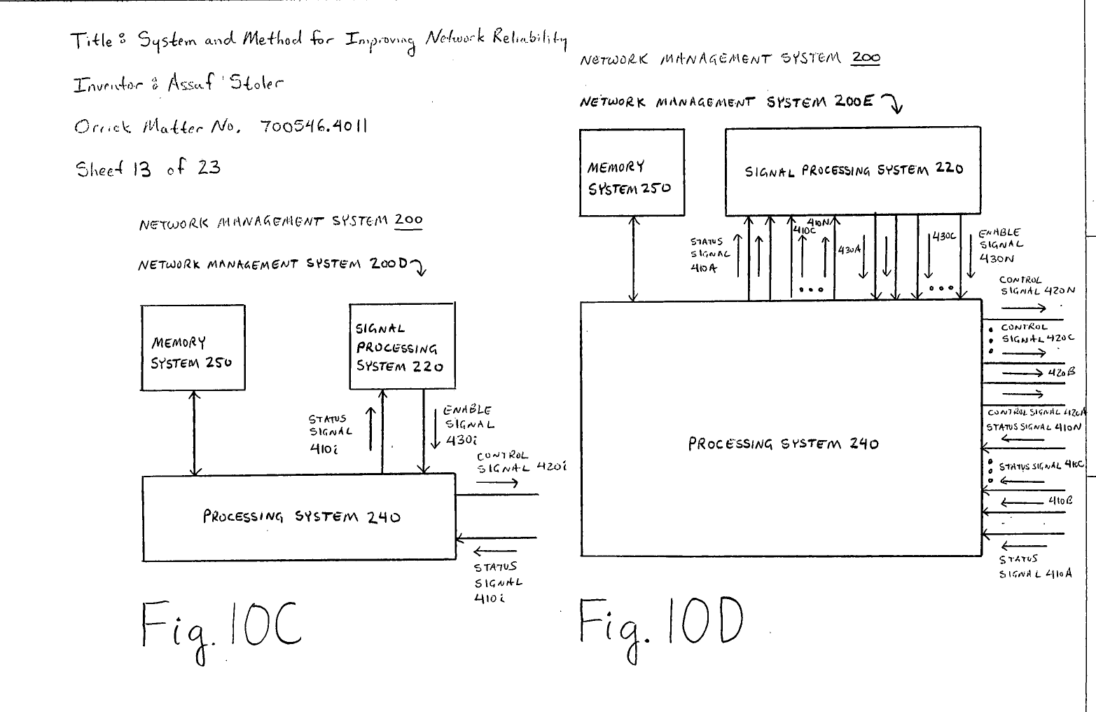

In a preferred embodiment, the network management systems 200 is provided substantially in the manner described above regarding the server systems 300A, 300B (shown in FIG. 4). Turning to FIGS. 10A-D, for example, the illustrated network management systems 200 each are shown as including a processing system 240 and a memory system 250. Being provided in the manner discussed in more detail above with reference to the processing system 330 (shown in FIGS. 7A-C), the processing system 240 is configured to perform, and/or control the performance or, at least one of the preselected functions performed by the network management system 200. The memory system 250 likewise can be provided in the manner discussed in more detail above with reference to the memory systems 340 (shown in FIGS. 7A-C) and is configured to store and provide information, including instruction code, such as software or firmware, intermediate calculation results, and other information associated with the processing system 240 and/or the network management system 200. As desired, the signal processing system 220 can be separate from, and/or disposed substantially within, the processing system 240 in the manner discussed above with reference to FIGS. 7A-B. Being configured to communicate with the processing system 240, the memory system 250 likewise can be separate from, and/or disposed substantially within, the processing system 240 in the manner discussed above with reference to FIGS. 7B-C.

In the manner discussed above, the network management system 200 can be configured to exchange communication signals 400 with the network devices 300 (shown in FIG. 4) and/or the network system 500A (shown in FIG. 4). FIG. 10A, for example, illustrates a network management system 200B with a signal processing system 220 that is configured to exchange communication signals 400 with the network devices 300 and/or the network system 500A substantially via the processing system 240. At least a portion of the communication signals 400, such as status signals 410, likewise can be exchanged between the signal processing system 220 of network management system 200C and the network devices 300 and/or the network system 500A substantially directly as shown in FIG. 10B.

As desired, the network management system 200 and the network devices 300 and/or the network system 500A can exchange the communication signals 400 in a substantially serial manner as illustrated by network management system 200D of FIG. 10C and/or in a substantially parallel manner as illustrated by network management system 200E of FIG. 10D. Stated somewhat differently, sets of one or more communication signals 400 can be exchanged between the network management system 200 and the network devices 300 and/or the network system 500A over a selected period of time substantially in accordance with a suitable predetermined sequence and/or arrangement. Although shown and described as comprising the network management system 200A in FIG. 4 and the network management systems 200B-E in FIGS. 10A-D, respectively, for purposes of illustration, it is understood that the network management system 200 can comprise any type of network management system and is not limited to the illustrated embodiments.

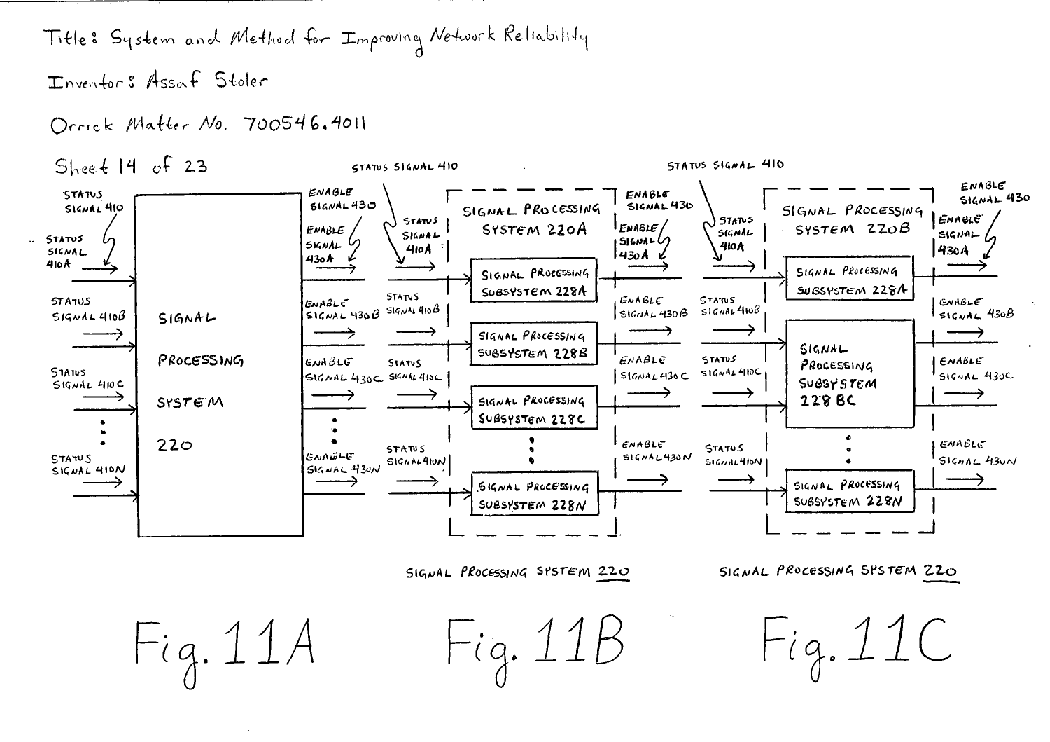

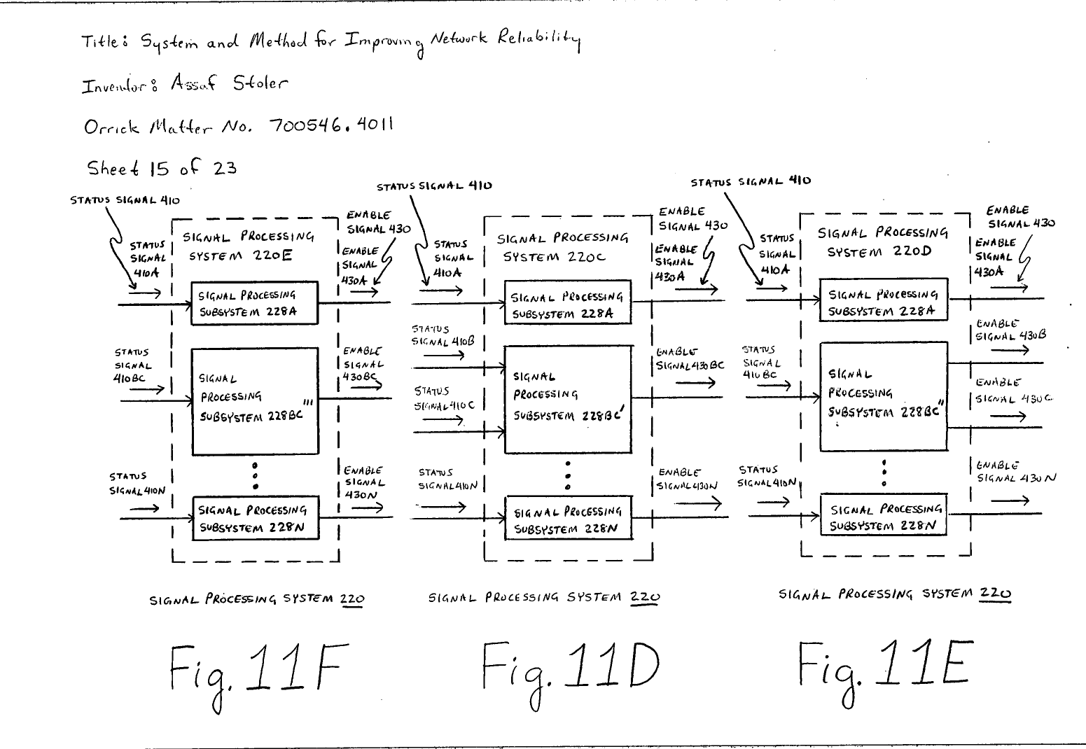

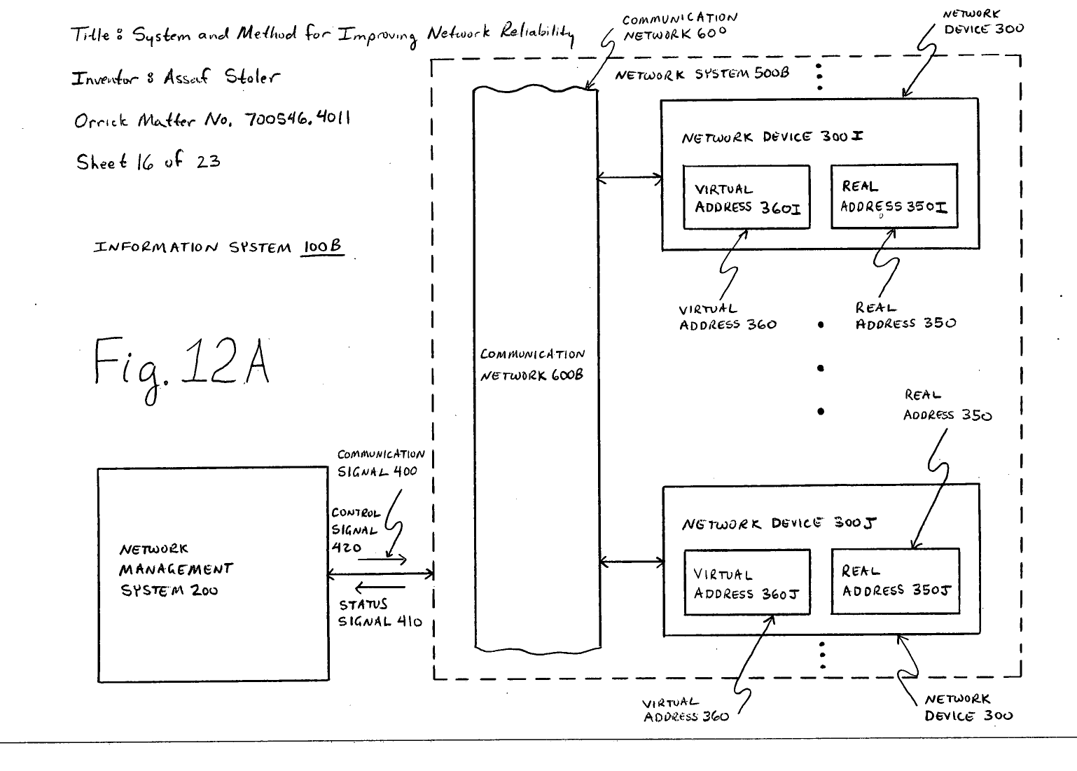

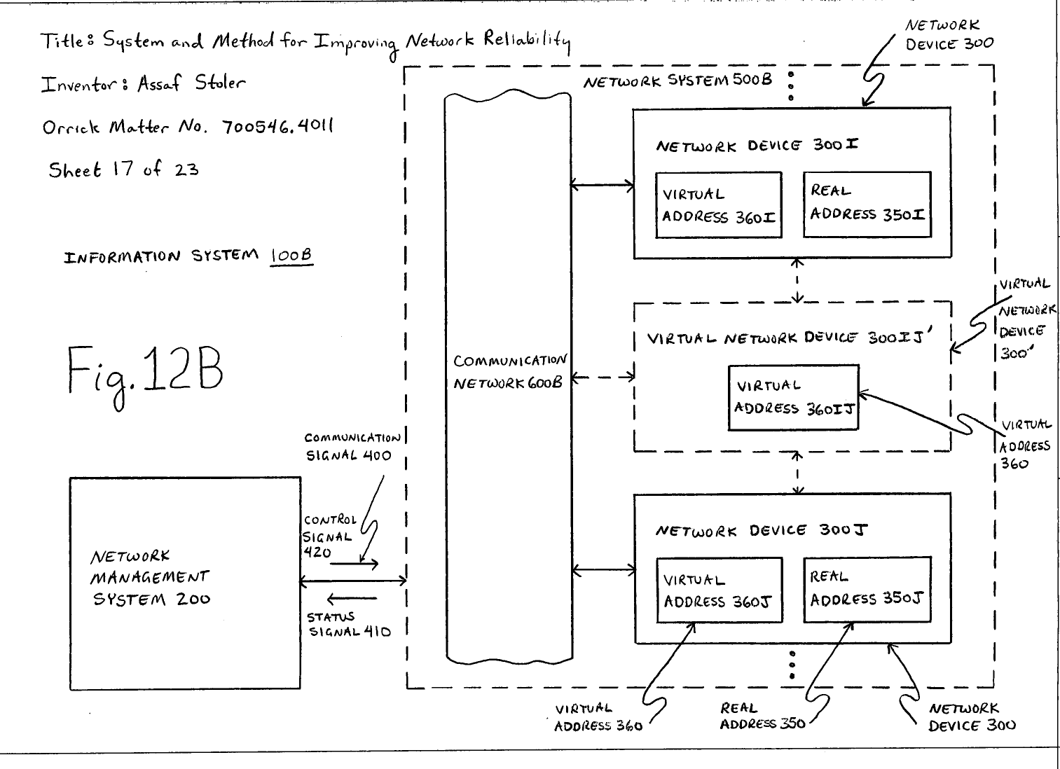

FIG. 11A is an exemplary block diagram illustrating one embodiment of a signal processing system 220 for the network management system 200A of FIG. 4. Being configured to receive status signals 410 from a plurality of network devices 300 (shown in FIG. 4) in the manner set forth above, the signal processing system 220 likewise can be configured to provide a plurality of enable signals 430 that are associated with the network devices 300. The signal processing system 220 can provide the plurality of enable signals 430 in any suitable, including any of the manners discussed in more detail above.

As illustrated in FIG. 11B, for example, the signal processing system 220 can be provided as a signal processing system 220A that comprises one or more signal processing subsystems 228A-N for receiving substantially independent status signals 410A-N and for providing substantially independent enable signals 430A-N in the manner discussed above. The signal processing subsystems 228A-N each can be provided in any suitable manner, such as in the manner discussed with regard to the signal processing system 220X (shown in FIG. 8A) and/or the signal processing system 220Y (shown in FIG. 9A). Although shown and described as being substantially separate for purposes of illustration, the signal processing subsystems 228A-N can include one or more common components, such as one or more common hardware components and/or software components. For example, two or more signal processing subsystems 228A-N can be provided via the processing system 240 (shown in FIGS. 10A-D).

As desired, one or more of the signal processing subsystems 228A-N can be configured to receive two or more substantially independent status signals 410A-N and/or to provide two or more substantially independent enable signals 430A-N. A signal processing system 220B is illustrated in FIG. 11C that includes a signal processing subsystem 228BC for receiving substantially independent status signals 410B, 410C and for providing substantially independent enable signals 430B, 430C for network devices 300B, 300C (collectively shown in FIG. 4). As shown in FIG. 11C, a number of status signals 410B, 410C received by the signal processing subsystem 228BC is substantially equal to a number of enable signals 430B, 430C provided by the signal processing subsystem 228BC. The signal processing subsystem 228BC might be appropriate, for example, when the substantially independent status signals 410B, 410C and/or the substantially independent enable signals 430B, 430C share one or more common characteristic. If the associated network devices 300B, 300C perform at least one related function, the signal processing subsystem 228BC likewise might be appropriate.

In addition, or alternatively, the number of status signals 410 received by a selected signal processing subsystems 228A-N can be greater than or less than the number of enable signals 430 provided by the selected signal processing subsystem 228A-N. Turning to FIG. 11D, the exemplary signal processing system 220C includes a selected signal processing subsystem 228BC′, which is configured to receive substantially independent status signals 410B, 410C and to provide enable signal 430BC. The enable signal 430BC can comprise a composite enable signal 430 that can be associated with one or more of the selected network devices 300B, 300C and might be appropriate, for example, if the selected network devices 300B, 300C perform at least one related function. Likewise, a signal processing system 220D is illustrated in FIG. 1E as having a selected signal processing subsystem 228BC″. The selected signal processing subsystem 228BC″ can receive a status signal 410BC and provide substantially independent enable signals 430B, 430C. The status signal 410BC can comprise a composite status signal 410 that is provided by one or more of the selected network devices 300B, 300C in the manner discussed in more detail above.

FIG. 11F shows a signal processing system 220E that includes a selected signal processing subsystem 228BC′″. Here, the selected signal processing subsystem 228BC′″ can receive a status signal 410BC and provide an enable signal 430BC. In the manner discussed above with reference to the status signal 410BC of FIG. 11E, the status signal 410BC can comprise a composite status signal 410 that is provided by one or more of the selected network devices 300B, 300C; whereas, the enable signal 430BC can comprise a composite enable signal 430 that is associated with one or more of the selected network devices 300B, 300C as set forth above with regard to the enable signal 430BC of FIG. 11D. The composite status signal 410BC and/or the composite enable signal 430BC can be advantageously employed to reduce the number of communication signals 400 (shown in FIG. 4) exchanged between the network management system 200 and the network devices 300 (shown in FIG. 4) and/or the network system 500A (shown in FIG. 4).

Although shown and described herein as being associated with two selected network devices 300B, 300C for purposes of illustration, the selected signal processing subsystems 228BC, 228BC′, 228BC″, and/or 228BC′″, the composite status signal 410BC, and/or the composite enable signal 430BC each can be associated with any suitable number of network devices 300. It is understood that the signal processing system 220 can comprise any type of signal processing system and is not limited to the illustrated embodiments despite being shown and described as comprising the signal processing systems 220A-E in FIGS. 1B-F, respectively, for purposes of illustration.

Returning again to FIG. 4, the signal processing system 220 can provide the enable signals 430 to the signal providing system 230. Upon receiving one or more of the enable signals 430, the signal providing system 230 is configured to evaluate the enable signals 430 to determine whether a malfunction is indicated with regard to any of the associated network devices 300 and to identify at least one appropriate corrective action for remedying any indicated malfunctions. The signal providing system 230 likewise can provide control signals 420, as necessary, to provide the appropriate corrective action to the associated network devices 300. The network management system 200A thereby is configured to detect and remedy malfunctions in the network device 300.

In the manner discussed in more detail above with regard to the enable signals 430i, 430i′, and 430i″ (shown in FIGS. 8A-B and 9A-B), the enable signals 430 preferably comprise at least two distinguishable signal states, including a first signal state that is associated with the absence of a malfunction indication in the associated network devices 300 and a second signal state that is associated with the presence of a malfunction indication. Upon receiving the enable signals 430, the signal providing system 230 evaluates the enable signals 430 to determine whether any malfunctions are indicated. When each are in the first signal state, the enable signals 430 provide no indication to the signal providing system 230 that a malfunction has occurred. Since no malfunctions are indicated, the signal providing system 230 therefore is not required to identify appropriate corrective action and/or to provide control signals 420 to the network devices 300. If one or more of the selected enable signals 430 enters the second signal state, however, the selected enable signals 430 indicate that at least one associated network device 300 has experienced a malfunction, and the signal providing system 230 is configured to identify appropriate corrective action and to provide control signals 420 to the associated network device 300.

As discussed above with reference to FIG. 1, exemplary corrective actions can include restarting at least one hardware and/or software component of the associated network device 300, restarting at least one hardware and/or software component of the network system 500 (shown in FIG. 2) to which the associated network device 300 is coupled, and/or at least temporarily redirecting one or more functions performed by the associated network device 300 to one or more other selected network devices 300. The signal providing system 230 likewise can elect to reload one or more software components, such as a network device driver and/or application software, associated with the associated network device 300 and/or to ignore the malfunction such that no corrective action is taken to remedy the indicated malfunction. It will be appreciated that the corrective actions enumerated above are merely exemplary and not exhaustive.

The signal providing system 230 can identify one or more corrective actions for remedying the indicated malfunction in any appropriate manner. For example, the signal providing system 230 can be configured to evaluate information provided by current enable signals 430 and/or historical enable signals 430, including a quantity and/or a frequency of any prior malfunction indications for the associated network device 300. Information regarding prior corrective actions taken to remedy any prior malfunction indications for the associated network device 300 likewise can be evaluated by the signal providing system 230. As desired, the signal providing system 230 can evaluate other information to identify corrective actions for remedying the malfunction indication for the associated network device 300.

For example, information associated with one or more other network devices 300, such as information regarding any current and/or prior corrective actions and/or information provided by current and/or historical enable signals 430 for the other network devices, can be evaluated. The evaluation of information associated with the other network devices 300 might be appropriate, for instance, when the malfunction indications for the associated network device 300 and the other network devices 300 are substantially similar and/or when the associated network device 300 and the other network devices 300 perform at least one related function. In the manner set forth above, illustrative network devices 300 that perform at least one related function include the server system 300B being configured as a print server system for managing the printing system 300D. As desired, the signal providing system 230 can evaluate current and/or historical information associated with the network system 500A and/or the communication network 600A.

Alternatively, or in addition, the signal providing system 230 can include associations between the information under evaluation for remedying the indicated malfunctions and one or more potential corrective actions. The associations can be provided in any suitable manner, such as a look-up table (not shown) and/or a database system (not shown) of any kind. If the network management system 200A includes a processing system 240 and a memory system 250 as set forth above with reference the signal processing system 240 (shown in FIGS. 10A-D), the look-up table and/or the database system can be provided by the processing system 240 and the memory system 250. Like the signal processing system 240, the signal providing system 230 can be separate from, and/or disposed substantially within, the processing system 240, as desired.

Upon determining that a malfunction has been indicated for the associated network device 300, the signal providing system 230 can identify at least one appropriate corrective action for remedying the indicated malfunction. If signal providing system 230 determines that the indicated malfunction may be remedied by more than one corrective action, such as two or more corrective actions in the alternative and/or in combination, instruction for implementing the corrective action can be included with the corrective action. Exemplary instructions include a sequence by which the corrective actions can be implemented. The signal providing system 230 can incorporate the corrective action and/or any other associated information, such as any implementation instruction, into at least one control signal 420. As desired, the signal providing system 230 may provide no control signal 420, for example, in the absence of any malfunction indications and/or upon electing to ignore one or more of the malfunction indications.

The signal providing system 230 is configured to provide the control signal 420 to at least one associated network device 300. In the manner discussed above with reference to the signal processing system 230 of FIGS. 10A-D, the network management system 200 can be configured to exchange communication signals 400 with the network devices 300 and/or the network system 500A in any suitable manner. For example, the signal providing system 230 can exchange the communication signals 400, including the control signal 420, with the network devices 300 and/or the network system 500A substantially directly and/or indirectly via one or more intermediate systems, such as the processing system 240. The signal providing system 230 and the network devices 300 and/or the network system 500A likewise can exchange the communication signals 400 in a substantially serial manner and/or in a substantially parallel manner.

Upon receiving the control signal 420, the associated network device 300 is configured to implement the corrective action identified in the control signal 420 substantially in accordance with any implementation instructions included therewith. The associated network device 300 likewise can provide the result of implementing the corrective action to the network management system 200A via a subsequent status signal 410 such that the network management system 200A can determine whether any further corrective action is warranted and/or desirable in the manner discussed above. Thereby, the network management system 200 is configured to detect and remedy malfunctions, if any, in the network devices 300, preferably in a manner that is substantially transparent to a system user.

To help ensure that any malfunctions can be detected and remedied in a manner that is substantially transparent to a system user, the corrective action identified by the network management system 200 can include at least temporarily redirecting one or more functions performed by a malfunctioning network device 300 to one or more other network devices 300 in the manner discussed above with reference to FIG. 1. The information system 100 can be configured to redirect functions performed by the malfunctioning network device 300 in any suitable manner. As desired, the information system 100 likewise can be configured to redirect functions performed by network devices 300 that become disconnected from the information system 100, such as when a network device 300 is removed from the information system 100 for purposes of scheduled maintenance and/or is replaced by another network device 300 subsequently coupled with the information system 100.

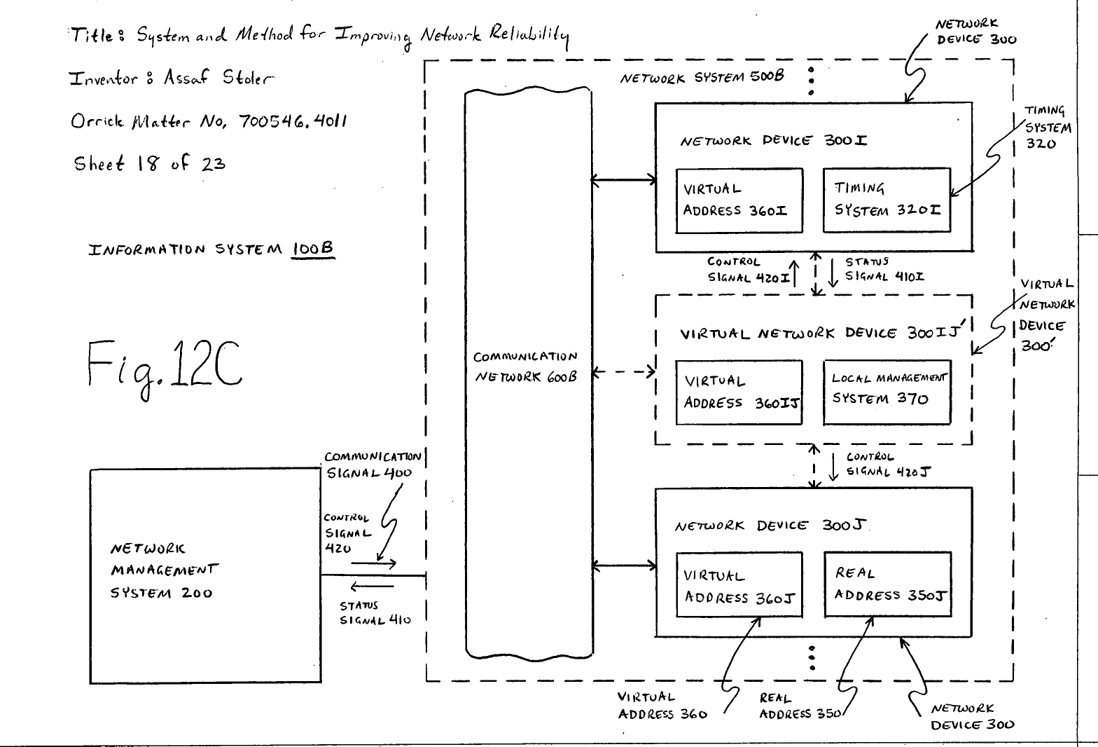

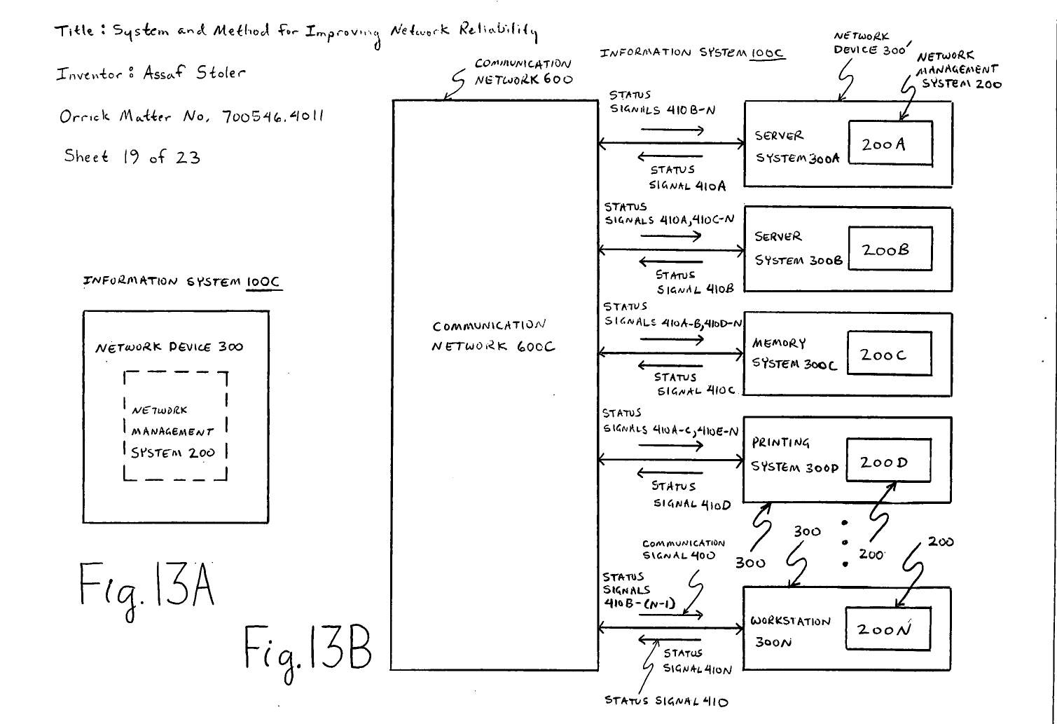

Turning to FIG. 12A, for example, an information system 100B is shown with a plurality of network devices 300 each being provided in the manner discussed in more detail above, including with reference to FIGS. 1, 2, 3A-B, and 4. Each of the network devices 300 is configured to perform at least one selected function and can have a real (or physical) address 350, such as a Media Access Control (MAC) address, and a virtual (or logical) address 360, such as an Internet Protocol (IP) address. The real address 350 for each network device 300, typically being hardware-dependent, is substantially fixed; whereas, the virtual addresses 360 generally are software-dependent and can be changed. In the manner set forth above, the network devices 300 can be configured to communicate, such as via a communication network 600B, to form a network system 500B. The network system 500B and the communication network 600B each can be provided in the manner discussed above.

Two exemplary network devices 300I, 300J are illustrated in FIG. 12A. The network device 300I is shown as being associated with the real address 350I and the virtual address 360I; whereas, the real address 350J and the virtual address 360J are shown as being associated with the network device 300J. Each comprising any suitable type of network device 300, such as a server system 300A, 300B (shown in FIG. 4), a memory system 300C (shown in FIG. 4), a printing system 300D (shown in FIG. 4), and/or a workstation 300N (shown in FIG. 4), in the manner discussed in more detail above, the network devices 300I, 300J preferably are substantially the same type of network device 300, such as server systems 300A, 300B.

The network devices 300I, 300J each are configured to perform at least one selected function, including one or more common functions that can be performed by the network device 300I and the network device 300J. Thereby, if one of the network devices 300I, 300J, such as network device 300I, malfunctions, the common functions can be performed by the other network device 300I, 300J, such as network device 300J, while the malfunction is being remedied. Although two network devices 300I, 300J are shown and described as being configured to perform the common functions for purposes of illustration, the common functions can be performed by any number of network devices 300. Likewise, the network device 300I can be configured to perform at least one function that is common with one or more other network devices 300 other than network device 300J; whereas, one or more other network devices 300, other than network device 300I, can be configured to perform at least one function that is common with the network device 300J.

Since the common functions can be performed by either the network device 300I or the network device 300J, the network system 500B can be configured to include one or more virtual network devices 300′, such as virtual network device 300IJ″, as illustrated in FIG. 12B. Being configured to communicate with one or more associated network devices 300 substantially directly and/or indirectly, for example, via the communication network 600B, each virtual network device 300′ can be associated with one or more of the common functions performed by the associated network devices 300 and can be associated with a virtual (or logical) address 360 in the manner discussed above with reference to FIG. 12A. As shown in FIG. 12B, the virtual network device 300IJ′ can communicate with the communication network 600B, the network device 300I, and the network device 300J and is associated with one or more of the common functions performed by the network devices 300I, 300J.

It will be appreciated that the common functions performed by the network devices 300I, 300J can be distributed among any number of the virtual network device 300′. For example, each common function can be associated with one virtual network device 300′ and/or each virtual network device can be associated with a plurality of common functions. Although the exemplary virtual network device 300IJ′ is shown and described as being associated with functions that are common to two network devices 300I, 300J for purposes of illustration, the network system 500B can be extended to include any suitable number of virtual network device 300′, each being associated with any number of functions that are common to any number of network devices 300.

Being associated with one or more of the common functions performed by the network devices 300I, 300J, the virtual network device 300IJ′ likewise is illustrated as being associated with a virtual address 360IJ. As desired, function requests can be broadcast over the network system 500B to the virtual network devices and/or to one or more of the network devices 300I, 300J. Upon receiving a function request to perform a selected common function via the network system 500B, the virtual network device 300IJ′ preferably is configured to direct a preselected network devices 300I, 300J to execute the function request substantially in accordance with one or more predetermined criteria. In other words, the virtual network device 300IJ′ can map function requests directed to the virtual address 360IJ to the virtual address 360I, 360J and/or the real address 350I, 350J of the preselected network device 300I, 300J. The preselected network device 300I, 300J then can perform the selected common function and can provide any result to the network system 500B and/or the virtual network device 300IJ′ via the virtual address 360IJ. As desired, the virtual network device 300IJ″, in turn, can provide the result of the function request to the network system 500B.

The predetermined criteria can comprise any appropriate criteria for distributing function requests among the network devices 300I, 300J. For example, the predetermined criteria can provide that such function requests should normally be provided to the network device 300I and that, if the network device 300I experiences a malfunction, the function requests should be provided to the network device 300J until the malfunction is remedied. Therefore, in accordance with the exemplary predetermined criteria, the virtual network device 300IJ″, upon receiving a function request to perform the selected common function, normally directs the function request to the network device 300I. In the manner set forth above, the network device 300I can perform the selected common function and provide any result of the function request to the network system 500B and/or the virtual network device 300IJ″.

The network management system 200 however can receive an indication that the network device 300I is malfunctioning in the manner set forth above, for example, with reference to FIGS. 4, 8B, and 9B. In the manner discussed above, the network management system 200 can provide a control signal 420 to the virtual network device 300IJ″, which control signal 420 can include an instruction to the virtual network device 300IJ′ to redirect any future function requests to perform the selected common function from the malfunctioning network device 300I to the network device 300J. The virtual network device 300IJ′ thereby is configured to direct any such function requests to the network device 300J in the manner set forth above pending further instruction from the network management system 200 regarding the status of the network device 300I. As such, the network management system 200 can remedy the malfunction in the network device 300I in a manner that is substantially transparent to a system user.

The virtual network device 300IJ′ can redirect any future function requests to perform the selected common function in any suitable manner. For example, the virtual network device 300IJ′ can be configured to redirect the future function requests from the network device 300I to the network device 300J substantially coincident with detection, and/or an indication, of a malfunction with regard to the network device 300I. The virtual network device 300IJ′ likewise can redirect the future function requests at a predetermined time interval after the detection and/or indication of the malfunction. If the network device 300I is performing the selected common function when the malfunction is detected and/or indicated, the virtual network device 300IJ′ can permit the network device 300I to at least partially continue to perform the selected common function and/or can instruct the network device 300J to perform the selected common function, in whole or in part. Upon receiving an indication that the malfunction has been remedied, the virtual network device 300IJ′ likewise can be configured to redirect future function requests to perform the selected common function from the network device 300J to the network device 300I in the manner discussed above.

As desired, the information system 100B likewise can include a local management system 370 as shown in FIG. 12C. The local management system 370 is illustrating as being disposed in the virtual network device 300IJ″. Being configured to monitor the status of the network devices 300I, 300J associated with the virtual network device 300IJ″, the local management system 370 can be provided in any suitable manner and can receive status signals 410 from the network devices 300 and/or provide control signals 420 to the network devices 300 each in the manner set forth above with regard to the network management system 200. The network device 300I is illustrated as including a timing system 320I for providing a status signal 410I. The status signal 410I that includes information, such information with regard to any malfunctions, concerning the network device 300I. The timing system 320I and the status signal 410I can be provided in the manner set forth above with reference to the timing system 320 (shown in FIG. 4) and the status signal 410 (shown in FIG. 4), respectively.

The local management system 370 is configured to receive the status signal 410I and to provide control signals 420I, 420J for the respective network devices 300I, 300J. In addition to, and/or instead of, providing information related to the appropriate corrective action for remedying malfunctions in the network devices 300I, 300J in the manner discussed above, the control signal 420 can include instruction for directing function requests to perform at least one selected common function associated with the network devices 300I, 300J. The network devices 300I, 300J can receive the respective control signals 420I, 420J and implemented the included instruction for directing such function requests. The local management system 370 can be provided as a supplement to, and/or as a substitute for, the network management system 200. Thereby, the information system 100B can provide a more localized mechanism for detecting and remedying malfunctions in, and/or for controlling the operation of, the network devices 300I, 300J. Although shown and described as being disposed in the virtual network device 300IJ′ for purposes of illustration, the local management system 370 can be disposed at any suitable location in the network system 500B, including in any of the network devices 300J, such as the network device 300J.

In operation, the network devices 300I, 300J can be operational such that each can perform the selected common function. In the manner discussed above, the predetermined criteria for distributing function requests to perform the selected common function can provide that such function requests should normally be provided to the network device 300I and that, if the network device 300I experiences a malfunction, the function requests should be provided to the network device 300J until the malfunction is remedied. When a first function request is broadcast, the local management system 370 is configured to direct the network device 300I to execute first function request in accordance with the predetermined criteria because no malfunction indication has been received with regard to the network device 300I. In the manner set forth above, the network device 300I can perform the selected common function and provide any result of the function request to the network system 500B.

If the local management system 370 receives the status single 410I that indicates the network device 300I has experienced a malfunction, the local management system 370 can provide the control signals 420I, 420J. In accordance with the predetermined criteria, the control signal 420I is configured to inhibit the network device 410I from performing the selected common function; whereas, the control signal 420J is configured to enable the network device 410J to perform the selected common function. As desired, the control signal 420I likewise can provide instruction for remedying the malfunction. When a second function request is broadcast, therefore, the network device 300J executes the second function request and can provide any result of the function request to the network system 500B since the malfunction indication for the network device 300I. Similarly, the network device 300J can be configured to execute any future function request in accordance with the predetermined criteria until the status single 4101 indicates the malfunction has been remedied.

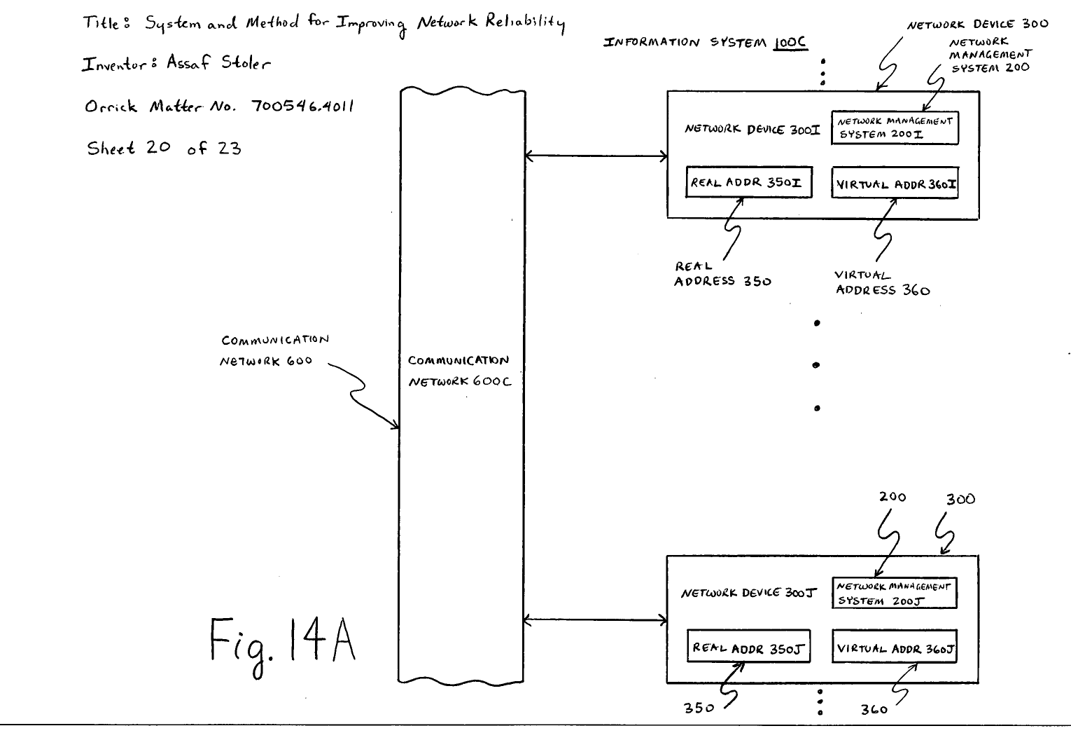

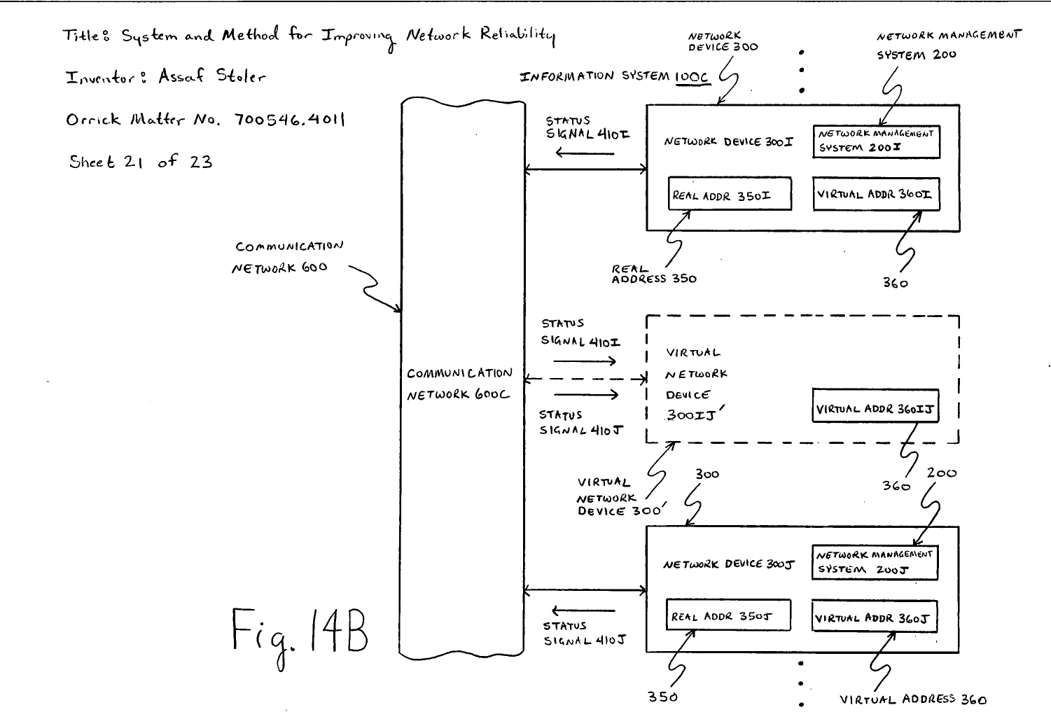

Although shown and described as comprising a central network management system 200 for purposes of illustration, the information system 100 can be provided with any conventional system topology, protocol, and/or architecture. For example, the network management system 200 can be at least partially disposed within at least one network device 300 as illustrated by information system 100C of FIG. 13A. FIG. 13B illustrates the information system 100C as comprising a plurality of network devices 300 with the network management system 200 being disposed within, and distributed among, the network devices 300. As desired, the information system 100C likewise can include one or more network devices 300 that are separate from the network management system 200 and/or one or more network devices 300 that are not configured to communicate with the network management system 200.

The network devices 300 are provided as set forth in more detail above with reference to FIG. 2 and are illustrated in FIG. 13B as including server systems 300A, 300B, a memory system 300C, a printing system 300D, and a workstation 300N in the manner discussed above with reference to FIG. 4. Being configured to communicate, exchanging communication signals 400, as discussed above, the network devices 300 can be coupled, and configured to communicate, via a communication network 600C. The communication network 600C can comprise any conventional wired and/or wireless communication network in the manner set forth above regarding the communication network 600 (shown in FIGS. 3A-B) and is configured to facilitate communications among the network devices 300. Thereby, each network device 300 can communicate with at least one other network device 300 in the information system 100C and preferably can communicate with substantially each of the other network devices 300.

The information system 100C likewise can include a network management system 200 for detecting malfunctions in the network devices 300 in the manner discussed above. The network management system 200 is illustrated as comprising a plurality of network management systems 200A-N. Being disposed within, and distributed among, the network devices 300A-N, each of the network management systems 200A-N can be provided in any suitable manner. Each of the network management systems 200A-N can include one or more hardware components and/or software components and can be integrated with, or substantially separate from, the hardware components and/or software components of the associated network device 300A-N. The network management systems 200A-N and the associated network devices 300A-N preferably comprise separate components to inhibit the operation of the network management systems 200A-N from being effected by any malfunctions of the associated network devices 300A-N. The network management systems 200A-N likewise can be provided in a manner that is substantially uniform, and/or differs, among the network devices 300A-N.

As set forth above, each of the network management systems 200A-N is configured to detect any malfunctions in the associated network device 300A-N. For example, each of the network devices 300A-N can provide a status signal 410A-N in the manner discussed in more detail above with reference to FIG. 4. Preferably including information, such as an operational status and/or performance data, pertaining to the relevant network device 300A-N, the status signals 410A-N are communicated by the network devices 300A-N to one or more of the network management systems 200A-N. For example, the server system 300A can provide the status signal 410A to each of the network devices 300A-N or to the subset of network devices 300, such as the server system 300B, that have one or more common characteristics with the server system 300A. The server system 300A likewise can provide the status signal 410A to the network management system 200A as desired. In other words, each of the network devices 300A-N can provide the associated status signals 410A-N to the network management systems 200A-N of a portion, and/or substantially all, of the network devices 300A-N. Each network device 300A-N thereby can alert at least one of the other network devices 300A-N if a malfunction occurs.

Upon receiving the status signals 410A-N, each network management system 200A-N can evaluate the received status signals 410A-N as discussed above, determining whether any of the associated network devices 300A-N have malfunctioned and, if so, providing a suitable response to the malfunction. The network management systems 200A-N can respond to the malfunction by attempting to remedy the malfunction, such as by identifying one or more appropriate corrective actions for remedying the malfunction, and/or by ignoring the malfunction such that no corrective action is taken to remedy the malfunction in the manner set forth in more detail above. For example, depending upon the nature of the malfunction, the network management systems 200A-N can attempt to repair the malfunction, such as by reloading one or more software components and/or by restarting one or more hardware and/or software component of the malfunctioning network device 300A-N.

The network management systems 200A-N likewise can at least temporarily redirect one or more functions performed by the malfunctioning network device 300A-N to one or more other selected network devices 300A-N. If the malfunction can be repaired via the network management systems 200A-N, the performance of at least one of the redirected functions can be restored to the malfunctioning network device 300A-N, once repaired; otherwise, the selected network devices 300A-N continue to perform the redirected functions until the malfunction can be otherwise addressed and/or resolved. As set forth in more detail above with reference to FIGS. 12A-C, the network management systems 200A-N temporarily redirect functions performed by malfunctioning network devices 300A-N to one or more other selected network devices 300A-N such that malfunctions preferably are detected and remedied in a manner that is substantially transparent to system users.

For example, the server system 300A can provide the status signal 410A, indicating that a malfunction has occurred. The server system 300A can provide the status signal 410A to the network management system 200A. As discussed above, the network management system 200A can respond to the status signal 410A by determining that the server system 300A has malfunctioned and by providing a suitable response to the malfunction. If an election is made not to ignore the malfunction, the network management system 200A, being associated with the malfunctioning server system 300A, can attempt to repair the malfunction in the manner set forth above. The malfunctioning server system 300A thereby can be repaired and returned to service if the repairs are successful. Once repaired and returned to service, the server system 300A can provide the status signal 410A that indicates that the server system 300A is not experiencing a malfunction.

During the repairs, the server system 300A likewise can provide the status signal 410A to one or more of the other network devices 300B-N. Upon receiving the status signal 410A, the network management systems 200B-N of the other network devices 300B-N can respond to the status signal 410A by determining that the server system 300A has malfunctioned and by providing a suitable response to the malfunction as set forth above. If the malfunction is not ignored, the network management systems 200B-N can redirect one or more functions performed by the malfunctioning server system 300A to any suitable number of the other selected network devices 300B-N. Although each preferably has one or more characteristics in common with the malfunctioning server system 300A, the other selected network devices 300B-N can comprise substantially uniform and/or different types of network devices 300.

Since the server system 300B and the workstation 300N can readily be configured to perform the functions originally performed by the malfunctioning server system 300A, the network management systems 200B, 200N can redirect one or more of the functions performed by the malfunctioning server system 300A to the server system 300B and/or the workstation 300N. The number of redirected functions to be performed by the server system 300B and/or the workstation 300N can be determined in any suitable manner and preferably is at least partially based upon the available resourced of the server system 300B and/or the workstation 300N. Upon receiving the status signal 410A that indicates that the server system 300A is not experiencing a malfunction, the network management systems 200B, 200N can determine that the server system 300A has been repaired and can restore the performance of the redirected functions to the server system 300A as discussed above. Although shown and described as including one malfunctioning server system 300A for purposes of illustration, the information system 100C can include two or more malfunctioning network devices 300, which can comprise substantially uniform and/or different types of network devices 300.

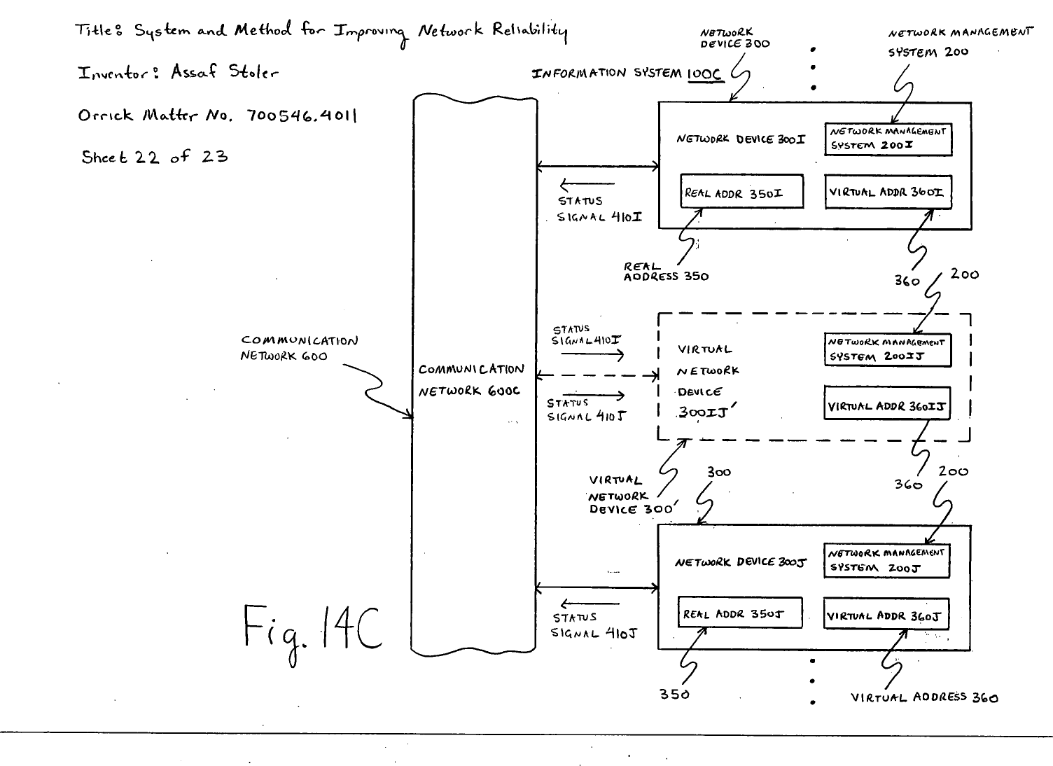

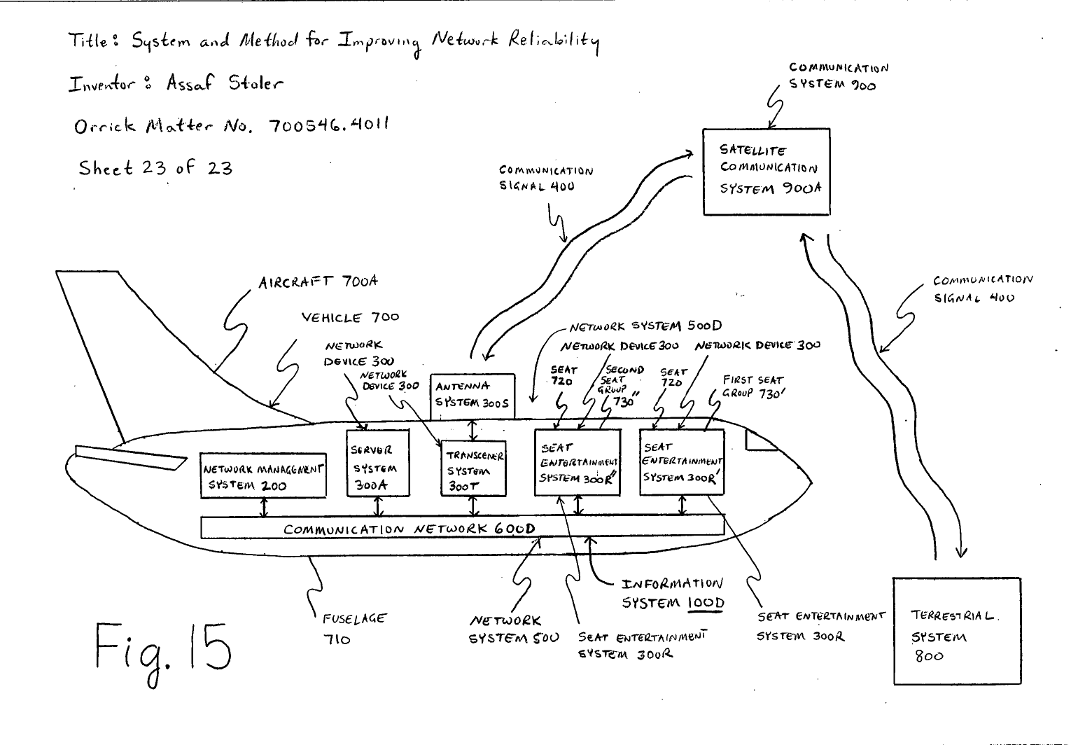

Turning to FIG. 14A, for example, the information system 100C is shown with a plurality of network devices 300I, 300J for performing selected functions and a plurality of network management systems 200I, 200J for detecting malfunctions in the network devices 300I, 300J in the manner discussed in more detail above with reference to FIGS. 13A-B. Each being provided in the manner set forth above, the network management systems 200I, 200J are disposed within, and distributed among, the network devices 300I, 300J. The network devices 300I, 300J likewise include a real (or physical) address 350 and a virtual (or logical) address 360 in the manner discussed in more detail above with reference to FIGS. 12A-C. The network device 300I is shown as being associated with the real address 350I and the virtual address 360I; whereas, the real address 350J and the virtual address 360J are shown as being associated with the network device 300J. As discussed above, the real address 350 for each network device 300 is substantially fixed; whereas, the virtual addresses 360 can be changed. Although shown and described as comprising substantially the same type of network device 300, such as server systems 300A, 300B (shown in FIG. 13B), for purposes of illustration, the network devices 300I, 300J each can comprise any conventional network device 300, including different types of network device 300.

As discussed above with reference to FIGS. 12A-C, the network devices 300I, 300J each can perform at least one common function. Since the common functions can be performed by either the network device 300I or the network device 300J, the information system 100C can be configured to include one or more virtual network devices 300′, such as virtual network device 300IJ″, as shown in FIGS. 14B-C. The virtual network device 300IJ′ can be provided in the manner set forth above with reference to FIGS. 12B-C, and is shown in FIGS. 14B-C as being configured to communicate with one or more of the associated network devices 300I, 300J. Being associated with one or more of the common functions performed by the associated network devices 300I, 300J, the virtual network device 300IJ′ can include a virtual network management system 200IJ, as shown in FIG. 14C, and can be associated with a virtual (or logical) address 360, such as virtual address 3601J, in the manner discussed above with reference to FIGS. 12B-C. Although shown and described as being provided via one virtual network device 300IJ′ for purposes of illustration, the common functions can be distributed among, and provided by, any suitable number of virtual network devices 300IJ′ as discussed above.

In the manner set forth in more detail above with reference to FIGS. 12B-C, function requests can be communicated to the network device 300I, the network device 300J, and/or the virtual network device 300IJ′. Upon receiving a function request to perform a selected common function, the virtual network device 300IJ′ preferably is configured to direct a preselected network devices 300I, 300J to execute the function request substantially in accordance with one or more predetermined criteria. Stated somewhat differently, the virtual network device 300IJ′ can map function requests directed to the virtual address 3601J to the virtual address 3601, 360J and/or the real address 3501, 350J of the preselected network device 300I, 300J. The preselected network device 300I, 300J then can perform the selected common function and can provide any result to the communication network 600C and/or the virtual network device 300IJ′ via the virtual address 3601J. As desired, the virtual network device 300IJ′, in turn, can provide the result of the function request to the communication network 600C.

The predetermined criteria can comprise any appropriate criteria for distributing function requests among the network devices 300I, 300J. As discussed above with reference to FIGS. 12B-C, the predetermined criteria can provide that such function requests should normally be provided to the network device 300I and that, if the network device 300I experiences a malfunction, the function requests should be provided to the network device 300J until the malfunction is remedied. Therefore, in accordance with the exemplary predetermined criteria, the virtual network device 300IJ′, upon receiving a function request to perform the selected common function, normally directs the function request to the network device 300I. In the manner set forth above, the network device 300I can perform the selected common function and provide any result of the function request to the communication network 600C and/or the virtual network device 300IJ′.

If the network device 300I begins to malfunction, for example, the network device 300I can provide a status signal 410I in the manner set forth above with reference to FIG. 13B. The virtual network management system 200IJ of the virtual network device 300IJ′ can receive the status signal 410I, which can include an instruction to the virtual network device 300IJ′ to redirect any future function requests to perform the selected common function from the malfunctioning network device 300I to the network device 300J. The virtual network management system 200IJ thereby can configure the virtual network device 300IJ′ to direct any such function requests to the network device 300J in the manner set forth above pending an indication from the network device 300I that the network device 300I has been repaired and returned to service. As such, the use of the virtual network device 300IJ′ can remedy the malfunction in the network device 300I in a manner that is substantially transparent to a system user.

The information system 100 can be provided in a substantially stationary environment, such as a building, and/or can be disposed within a mobile environment. For example, at least a portion of the information system 100 can be disposed in a vehicle of any suitable kind. The information system 100 can be installed in a wide variety of vehicles, such as an automobile, a bus, an aircraft, a boat, or a locomotive, without limitation. In one preferred embodiment, the information system 100 can be configured as a passenger entertainment system, such as the passenger entertainment system disclosed in the co-pending patent application, entitled “System and Method for Downloading Files,” Ser. No. 10/772,565, filed Feb. 4, 2004, the disclosure of which is hereby incorporated by reference in its entirety.

FIG. 15 illustrates an information system 100D as installed at least in part on a vehicle 700, such as an aircraft 700A. Comprising any suitable type of aircraft, the aircraft 700A can include a fuselage 710 with at least one seat 720 and a network system 500D being disposed substantially therein. In the manner discussed in more detail above, for example, with reference to FIGS. 1, 2, 3A-B, and 4, the network system 500D is illustrated as having a plurality of network devices 300 that are configured to communicate. Being configured to communicate, exchanging communication signals 400 (shown in FIG. 1), as discussed above, the network devices 300 can be coupled, and configured to communicate, via a communication network 600D. The communication network 600D can comprise any conventional wired and/or wireless communication network in the manner set forth above regarding the communication network 600 (shown in FIGS. 3A-B) and is configured to facilitate communications among the network devices 300. The network devices 300 can comprise any suitable type of network devices and can be provided in the manner set forth above with regard to the network devices 300 (shown in FIG. 4). A network management system 200 likewise is shown as being included in the aircraft 700A and as being configured to communicate with the network devices 300 via the communication network 600D.

As desired, one or more network management systems 200 and/or network devices 300 can be provided in a substantially stationary environment, such as within a terrestrial system 800, and configured to communicate with the network system 500D. Being substantially stationary relative to the network system 500D, the terrestrial system 800 preferable is coupled with the network system 500D via a wireless communication system 900, such as a satellite communication system 900A, as illustrated in FIG. 15. The satellite communication system 900A can comprise any number of geostationary satellites (not shown), which are configured to communicate with the terrestrial station 800. When the aircraft 700A and the terrestrial station 800 each are within transmission range of at least one of the satellites, communication signals 400 can be exchanged between the network management systems 200 and/or network devices 300 of the network system 500D and the network management systems 200 and/or network devices 300 of the terrestrial station 800 via the satellite communication system 900A. Although shown and described as a satellite communication system 900A for purposes of illustration, it is understood that the communication system 900 can comprise any suitable type of wireless communication system, such as a cellular communication system (not shown).

To facilitate communication between the network system 500D and the terrestrial station 800, at least one of the network devices associated with the network system 500D and/or at least one of the network devices associated with the terrestrial station 800 can be configured to communicate with the satellite communication system 900A. As illustrated in FIG. 15, the network system 500D can include an antenna system 300S that is coupled with, and configured to communicate with, a transceiver system 300T. Being mounted on the outer fuselage 710 of the aircraft 700A, the antenna system 300S is configured to receive incoming communication signals 400 from the terrestrial station 800 via the satellite communication system 900A and to provide the incoming communication signals 400 to the transceiver system 300T, which can be configured to process the incoming communication signals 400. The transceiver system 300T, for example, can decode, demodulate, and/or analog-to-digital convert the incoming communication signals 400 as desired. Upon processing the incoming communication signals 400, the transceiver system 300T can provide the processed incoming communication signals 400 to the network system 500D.

Outgoing communication signals 400 provided by the network system 500D likewise can be transmitted by the antenna system 300S to the terrestrial station 800 via the satellite communication system 900A. The network system 500D provides the outgoing communication signals 400 to the transceiver system 300T, which processes the outgoing communication signals 400. Exemplary processes can include encoding, modulating, and/or analog-to-digital converting the outgoing communication signals 400 as desired. The transceiver system 300T can provide the processed outgoing communication signals 400 to the antenna system 300S for transmission to the satellite communication system 900A. When the communication signals 400 are exchanged, the antenna system 300S is directed substantially toward one or more of the satellites in the satellite communication system 900A. Since the network system 500D is mobile, the antenna system 300S preferably is coupled with an antenna controller (not shown) for steering the antenna system 300S such that the antenna system 300S can track the satellites in any known manner such as by locking onto the incoming communication signals 400 transmitted by the satellite communication system 900A.

If the information system 100D is configured as a passenger entertainment system, at least one of the network devices can comprise a server system 300A as shown in FIG. 15. The server system 300A can provide entertainment content to the passengers aboard the aircraft 700A. As desired, the network system 500D can be configured to enable the server system 300A to upload files, such as entertainment content, from one or more file libraries associated with the terrestrial system 800 and/or to download files, such as performance information, to the terrestrial system 800. The file libraries can comprise any suitable type of files and can be provided in any appropriate analog and/or digital file format. Although the file libraries may be provided in any uncompressed format, the file libraries likewise can be provided in a compressed format to facilitate file downloads.

The file libraries, for example, can have entertainment files, including audio files, such as music or audio books, and/or video files, such as motion pictures, television programming, or any other type of audiovisual work. Illustrative file formats for the video files include Audio Video Interleave (AVI) format, Joint Photographic Experts Group (JPEG) format, and Moving Picture Experts Group (MPEG) format; whereas, Waveform (WAV) format and MPEG Audio Layer 3 (MP3) format comprise exemplary formats for the audio files. As desired, other types of files, including application software files, such as media player programs or games, and/or textual files, such as forms or reference materials, can be included in the database system 200. Application software files typically are provided in an executable (EXE) format, and exemplary file formats for the textual files include document text file (DOC) format, Portable Document Format (PDF), and text file (TXT) format.

It will be appreciated that the network system 500D likewise can be configured to download files that relate to the destination of the aircraft 700A. For example, passengers can download files that provide information relating to hotel accommodations or a map of the destination city. If the destination is an airport terminal, files comprising information, such as arrival and departure times and gate information, for other flights may be downloaded to assist the passenger with making his connecting flight or with meeting others who are arriving at the airport terminal on different flights.

As shown in FIG. 15, one or more network devices 300 can be associated with the seats 720, such as passenger seats, in the aircraft 700A. The seats 720, for example, can include seat entertainment systems 300R that are configured to communicate with the network system 500D. As desired, the seats 720 can be divided into a plurality of seat groups, such as first class passenger seats and coach class passenger seats. Seats 720 in a first seat group 730′ can include seat entertainment systems 300R′ that are associated with the first seat group 730′; whereas, a second seat group 730″ can comprise seats 720 with seat entertainment systems 300R″. The functionality of the seat entertainment systems 300R′ can differ from the functionality of the seat entertainment systems 300R″. For example, the seat entertainment systems 300R′ associated the seats 720 in the first seat group 730′ may be permitted to access premium content that is not available to the entertainment systems 300R″ associated the seats 720 in the second seat group 730″. The entertainment systems 300R″ associated the seats 720 in the second seat group 730″ likewise can require a fee to be paid prior to permitting access to the network system 500D; whereas, the entertainment systems 300R′ associated the seats 720 in the first seat group 730′ may be able to access the network system 500D without requiring payment of the fee.

It will be appreciated that the seat entertainment systems 300R can comprise any type of conventional seat entertainment systems for audibly and/or visually presenting entertainment content to passengers. For example, each seat entertainment systems 300R can include an input system (not shown), an audio system (not shown), and/or a video system (not shown). The input system permits the passenger to communicate instructions, such as instructions for selecting one or more files from available file libraries and/or instructions for controlling the presentation of the selected files, to the network system 500D. The audio system and the video system are respectively configured to present an audio portion and a video portion of the selected files. Other information, such as a menu of file libraries available for downloading, can be presented to the user via the interface system. Although each seat 720 preferably is associated with an independent seat entertainment system 300R, two or more seats 700 can share at least a portion of a common seat entertainment systems 300R such as via one or more overhead display systems.

The invention is susceptible to various modifications and alternative forms, and specific examples thereof have been shown by way of example in the drawings and are herein described in detail. It should be understood, however, that the invention is not to be limited to the particular forms or methods disclosed, but to the contrary, the invention is to cover all modifications, equivalents, and alternatives falling within the spirit and scope of the claims.

1. A network device, comprising:
a timing system being configured to provide a status signal including a series of pulse signals having time intervals between successive pulse signals in said series and being indicative of a malfunction in the network device if at least one of said time intervals is not substantially within a predetermined range of time intervals; and
a network management system for detecting a malfunction in the network device based upon said status signal and for providing a suitable response to the indicated malfunction.

2. The network device of claim 1, wherein said time intervals between said successive pulse signals are substantially uniform.

3. The network device of claim 1, wherein said predetermined range of time intervals is less than or substantially equal to sixty seconds.

4. The network device of claim 3, wherein said predetermined range of time intervals is within a range between approximately one second and fifteen seconds.

5. The network device of claim 3, wherein at least one of said time intervals comprises a five-second time interval.

6. The network device of claim 1, wherein each of said pulse signals further includes an amplitude, said amplitude being substantially uniform among said pulse signals.

7. The network device of claim 6, wherein said pulse signals are indicative of a malfunction if said amplitude of at least one of said pulse signals is not substantially within a predetermined range of amplitudes.

8. The network device of claim 6, wherein said pulse signals are indicative of a malfunction if said amplitude of at least one of said pulse signals is less than a preselected threshold amplitude.

9. The network device of claim 1, wherein said network management system comprises a passive signal processing system.

10. The network device of claim 1, wherein said network management system comprises an active signal processing system.

11. The network device of claim 1, wherein said network management system is at least partially disposed with said network device.

12. The network device of claim 1, wherein said suitable response comprises ignoring said malfunction.

13. The network device of claim 1, wherein said suitable response comprises corrective action for remedying said malfunction.

14. The network device of claim 13, wherein said corrective action includes restarting at least one component of said network device.

15. The network device of claim 13, wherein said corrective action includes reloading at least one software component of said network device.

16. The network device of claim 13, wherein said corrective action includes at least temporarily redirecting one or more functions performed by said network device to one or more other selected network devices.

17. The network device of claim 13, wherein said suitable response includes information for implementing said corrective action.

18. The network device of claim 1, wherein said network device comprises a server system.

19. The network device of claim 1, wherein said network device comprises a memory system.

20. The network device of claim 1, wherein said network device comprises a workstation.

21. An information system, comprising:
a first network device for performing at least one first function and including a first timing system for providing a first status signal being indicative of a malfunction in said first network device if at least one time interval between successive pulse signals comprising said first status signal is not substantially within a first predetermined range of time intervals; and
a second network device for performing at least one second function, said second network device being configured to communicate with said first network device and including a second timing system for providing a second status signal being indicative of a malfunction in said second network device if at least one time interval between successive pulse signals comprising said second status signal is not substantially within a second predetermined range of time intervals; and
a network management system comprising a first network management system for detecting a malfunction in said first network device based upon said first status signal and a second network management system for detecting a malfunction in said second network device based upon said second status signal, said network management system for providing a suitable response to said detected malfunction.

22. The information system of claim 21, wherein said first and second network devices are configured to communicate via a communication network.

23. The information system of claim 22 wherein said communication network comprises a wireless communication network.

24. The information system of claim 22, wherein said first and second network devices are coupled via said communication network.

25. The information system of claim 21, wherein said pulse signals comprising said first and second status signals are substantially uniform.

26. The information system of claim 25, wherein said time intervals between successive pulse signals comprising said first status signal are substantially uniform.

27. The information system of claim 25, wherein said time intervals between successive pulse signals comprising said second status signal are substantially uniform.

28. The information system of claim 21, wherein said pulse signals comprising said first and second status signals are temporally separate.

29. The information system of claim 21, wherein said network management system is at least partially disposed with at least one of said first and second network devices.

30. The information system of claim 29, wherein said network management system is distributed among said first and second network devices.

31. The information system of claim 29, wherein said first network management system is associated with said first network device, and wherein said second network management system is associated with said second network device.

32. The information system of claim 31, wherein said first network management system is integrated with said first network device, and wherein said second network management system is integrated with said second network device.

33. The information system of claim 31, wherein said first network management system is disposed within said first network device, and wherein said second network management system is disposed within said second network device.

34. The information system of claim 21, wherein said suitable response comprises ignoring said detected malfunction.

35. The information system of claim 21, wherein said suitable response comprises corrective action for remedying said detected malfunction.

36. The information system of claim 35, wherein said corrective action includes restarting at least one component of said network device.

37. The information system of claim 36, wherein corrective action includes reloading at least one software component of said network device.

38. The information system of claim 36, wherein said corrective action includes at least temporarily redirecting at least one of said at least one second function to said first network device.

39. The information system of claim 36, wherein said corrective action includes at least temporarily redirecting at least one of said at least one first function to said second network device.

40. The information system of claim 35, wherein said suitable response is performed in a manner that is substantially transparent to a system user.

41. The information system of claim 21, further comprising a virtual network device for performing at least one common function common to said at least one first and second functions, said network management system initially directing requests for said at least one common function to said first network device and, upon detecting said detected malfunction in said first network device, responding to said detected malfunction by redirecting said requests for said at least one common function to said second network device.

42. The information system of claim 41, wherein said network management system responds to said detected malfunction by temporarily redirecting said requests for said at least one common function to said second network device.

43. The information system of claim 41, wherein said network management system responds to said detected malfunction by attempting to repair said detected malfunction in said first network device.

44. The information system of claim 43, wherein said network management system responds to said detected malfunction by repairing said detected malfunction in said first network device and, once repaired, by restoring said requests for said at least one common function to said first network device.

45. The information system of claim 43, wherein said network management system responds to said detected malfunction by determining that said detected malfunction in said first network device cannot be repaired and by substantially permanently redirecting said requests for said at least one common function to said second network device.

46. The information system of claim 21, further comprising a third network device for performing at least one third function, said third network device being configured to communicate with said first and second network devices and including a third timing system for providing a third status signal being indicative of a malfunction in said third network device if at least one time interval between successive pulse signals comprising said third status signal is not substantially within a third predetermined range of time intervals, and wherein said network management system includes a third network management system for detecting a malfunction in said third network device based upon said third status signal and for providing suitable responses to said detected malfunction.

47. The information system of claim 21, further comprising a third network device for performing at least one third function, said third network device being configured to communicate with said first and second network devices, and wherein said network management system is not configured to detect and provide a suitable response to a malfunction in said third network device.

48. An information system, comprising:
a plurality of network devices for performing at least one function, each of said network devices being configured to communicate with at least one other network device in said plurality and including a timing system for providing a status signal being indicative of a malfunction in the network device if at least one time interval between successive pulse signals comprising said status signal is not substantially within a predetermined range of time intervals; and
a network management system for detecting a malfunction in one or more of said plurality network devices based upon said status signals and for providing a suitable response to said detected malfunction.

49. The information system of claim 48, wherein said plurality of network devices is configured to communicate via a communication network.

50. The information system of claim 49 wherein said communication network comprises a wireless communication network.

51. The information system of claim 49, wherein said plurality of network devices is coupled via said communication network.

52. The information system of claim 48, wherein said pulse signals comprising said status signals for each of said plurality of network devices are temporally separate.

53. The information system of claim 48, wherein said network management system is at least partially disposed with at least one of said plurality of network devices.

54. The information system of claim 53, wherein said network management system is distributed among said plurality of network devices.

55. The information system of claim 53, wherein said network management system comprises a plurality of network management systems each for detecting said detected malfunction in a selected network device based upon a relevant one of said status signals and for providing a suitable response to said detected malfunction.

56. The information system of claim 55, wherein each of said plurality of network management systems being disposed within said selected network device.

57. The information system of claim 48, wherein said suitable response comprises ignoring said detected malfunction.

58. The information system of claim 48, wherein said suitable response comprises corrective action for remedying said detected malfunction.

59. The information system of claim 48, further comprising a virtual network device for performing at least one common function common to at least two selected network devices in said plurality, said network management system initially directing requests for said at least one common function to a first one of said selected network devices and, upon detecting said detected malfunction in said first one of said selected network devices, responding to said detected malfunction by redirecting said requests for said at least one common function to a second one of said selected network devices.

60. The information system of claim 59, wherein said network management system responds to said detected malfunction by temporarily redirecting said requests for said at least one common function to said second one of said selected network devices.

61. The information system of claim 59, wherein said network management system responds to said detected malfunction by attempting to repair said detected malfunction in said first one of said selected network devices.

62. The information system of claim 61, wherein said network management system responds to said detected malfunction by repairing said detected malfunction in said first one of said selected network devices and, once repaired, by restoring said requests for said at least one common function to said first one of said selected network devices.

63. The information system of claim 61, wherein said network management system responds to said detected malfunction by determining that said detected malfunction in said first one of said selected network devices cannot be repaired and by substantially permanently redirecting said requests for said at least one common function to said second one of said selected network devices.

64. A method for detecting and responding to malfunctions in network devices, comprising:
providing a status signal including a series of pulse signals having time intervals between successive pulse signals in said series and being indicative of a malfunction in a first network device if at least one of said time intervals is not substantially within a predetermined range of time intervals;
determining whether said status signal is indicative of the malfunction in the first network device identifying at least one suitable response to the indicated malfunction in the first network device; and
implementing at least one of said at least one suitable response.

65. An entertainment system, comprising:
a plurality of network devices for providing entertainment content, each of said network devices being configured to communicate with at least one other network device in said plurality and including a timing system for providing a status signal being indicative of a malfunction in the network device if at least one time interval between successive pulse signals comprising said status signal is not substantially within a predetermined range of time intervals; and
a network management system for detecting a malfunction in one or more of said plurality network devices based upon said status signals and for providing a suitable response to said detected malfunction.

66. An aircraft, comprising:
a fuselage;
a passenger seat arranged within the fuselage; and
an in-flight entertainment system coupled with said fuselage and comprising:
a plurality of network devices for providing entertainment content to said passenger seat, each of said network devices being configured to communicate with at least one other network device in said plurality and including a timing system for providing a status signal being indicative of a malfunction in the network device if at least one time interval between successive pulse signals comprising said status signal is not substantially within a predetermined range of time intervals; and
a network management system for detecting a malfunction in one or more of said plurality network devices based upon said status signals and for providing a suitable response to said detected malfunction.
